(19) United States
(12) Patent Application Publication
(10) Pub. No.: US 2026/0035972 A1
(43) Pub. Date: Feb. 5, 2026

(54) IMPROVEMENTS TO LATCHES FOR MOVABLE BARRIERS OR THE LIKE

(71) Applicant: D&D Group Pty Ltd, Frenchs Forest (AU)

(72) Inventor: Linn Tun, Sydney (AU)

(21) Appl. No.: 18/995,383

(22) PCT Filed: Jul. 17, 2023
(86) PCT No.: PCT/AU2023/050656

§ 371 Date: Jan. 16, 2025

(30) Foreign Application Priority Data
Jul. 18, 2022 (AU) 2022902013

(51) Int. Cl. E05C 19/16; E05B 15/02; E05B 15/10; E05B 55/00; E05B 65/10

(52) U.S. Cl. CPC E05C 19/163; E05B 15/025; E05B 15/101; E05B 55/00; E05B 65/1053; E05Y 2201/46; E05Y 2201/68; E05Y 2201/702

(57) ABSTRACT

This invention relates to a latch arrangement (50) including a striker assembly (300), and a latch assembly (200). The striker assembly (300) includes a striker bolt (306) and a striker bolt housing (312) whereby the striker bolt (306) is movable relative to the striker housing (312) between an extended position and a retracted position. The latch assembly (200) is operable to retain the striker bolt (306) in the extended position and includes a keeper (204).

### TECHNICAL FIELD

The present invention relates to latch assembly, and particularly to an egress device mountable to a moveable barrier for securing the egress device to a structure, and in some embodiments, pad actuation device for releasing a striker pin.

### BACKGROUND ART

Egress devices are commonly used on doors in public settings, where a push bar, i.e. actuator, translates a user's push into the unlatching of the doors latch mechanism, allowing pedestrian entry or exit. The egress device translates a forward motion of the push bar into a lateral motion for withdrawing a latch bolt from a strike plate in an unlatched condition. The strike plate is typically mounted to a fixed post or frame, where the latch bolt and strike plate is used to secure the free end of the door in a latched condition.

Egress devices are designed and constructed to meet internationally recognised standards, such as BHMA156.3. For example, under one of the requirements of BHMA156.3 the maximum force for operating the push bar, i.e. unlatching the latch bolt from the strike plate is 67N (15 lbf). To control the unlatching force, the door hardware manufacturers have resulted in using a rotatable spindle on the strike plate for engaging the latch bolt. In addition, the face of the latch bolt may be profiled to follow the line displacement of the latch bolt, so the combination of the profiled face and the rotatable spindle reduces the friction between the latch bolt and the strike plate.

### SUMMARY

According to a first aspect, disclosed is an egress device for releasably securing a movable barrier to a structure. The moveable barrier can be e.g. a gate or door. The structure may be a fixed structure such as a gate post or a frame. The egress device comprises a latch assembly configured to co-operate with a striker assembly. The latch assembly comprises a keeper latch member and a keeper. The keeper latch member can be co-operable with the keeper. The keeper latch member extends between a first end and a second end, and can be moveable between an engaged position and a released position. The keeper includes a latch face and a strike face, and can be moveable between a first position and a second position. When the keeper latch member is in the engaged position the keeper is retained in the first position.

That is, when the keeper latch member and the keeper are engaged together, the keeper is retained in the first position.

In use, when the keeper latch member is in the engaged position, the second end of the keeper latch member engages the latch face of the keeper to retain the keeper in the first position.

When the keeper latch member is in the released position, the second end of the keeper latch member is disengaged from the latch face of the keeper and the keeper is operable to move to the second position to enable the moveable barrier, i.e. a gate to be moveable with respect to the structure, i.e. a gate post, to an open position.

In this way, the keeper latch member is able to engage the keeper in the first position to releasably secure the movable barrier to a structure. Upon disengagement of the keeper latch member from the keeper, the movable barrier, i.e. a gate, is movable into an open position.

In some forms, the striker assembly comprises a striker bolt movable between an extended position and a retracted position, such that when the striker assembly is brought into alignment with the latch assembly, the striker bolt moves to the extended position into engagement with the latch assembly. In use, when the keeper latch member is in the engaged position, the second end of the keeper latch member may engage the latch face of the keeper to retain the keeper in the first position such that the striker bolt may be retained in the extended position.

The keeper latch member engages the keeper such that the keeper can not move into the second, disengaged, position, thereby preventing the striker bolt from disengaging from the latch assembly.

When the keeper latch member is in the released position, the second end of the keeper latch member may be disengaged from the latch face of the keeper such that the striker bolt engages the strike face of the keeper to move the keeper to the second position to enable the moveable barrier to be moveable to the open position. When the keeper is disengaged from the keeper latch member, the keeper can be moved by the striker bolt such that the movable barrier, i.e. a gate, can be opened.

In some forms, the egress device further comprises an actuator assembly. The actuator assembly includes an actuator moveable between a raised position and a depressed position. When in the depressed position, the actuator assembly actuates the latch assembly by engaging the first end of the keeper latch member to move it to the released position to allow the striker bolt to move the keeper to the second position as the moveable barrier moves towards the open position.

That is, when the actuator is depressed, the actuator assembly acts to move the keeper latch member to the released position. This allows the striker bolt to move the keeper to the second position whereby the moveable barrier is free to move towards the open position.

According to a second aspect, disclosed is a passageway device comprising the egress device as set forth above, the passageway device further comprising a remote actuator for allowing the egress device to be operated from the remote side, i.e. another side, of the movable barrier. The remote actuator can be operable to move the keeper latch member between the engaged position and the released position. Advantageously, the remote actuator provides an alternative mechanism for moving the keeper latch member to the released position, i.e. for allowing the moveable barrier to open.

In some forms, the remote actuator may be operable to enable the keeper to be retained in the first position or may be operable to enable the keeper to be moved from the first position to the second position by the striker bolt as the movable barrier moves towards the open position.

In other words, the remote actuator may be used to keep the moveable barrier closed, i.e. retain the keeper in the first position, or to allow the moveable barrier to open, i.e. allow movement of the keeper from the first position to the second position.

According to a second aspect, disclosed is a latch arrangement for an egress bar assembly configured to be mountable to a moveable barrier and structure. The latch arrangement is configured to releasably secure the moveable barrier to the structure. The latch arrangement comprises a striker assembly configured to co-operate with a latch assembly. The striker assembly comprises a striker bolt and a striker bolt housing. The striker bolt housing contains at least a portion of the striker bolt. The striker bolt is moveable between an extended position and a retracted position. When the striker assembly and the latch assembly are in alignment, the striker bolt extends from the striker bolt housing in the extended position. When the striker assembly and the latch assembly are out of alignment, the striker bolt retracts into the striker bolt housing to the retracted position.

Advantageously, when the striker bolt is retracted into the striker bolt housing, the striker assembly is able to move freely past the latch assembly such that the moveable barrier does not contact the latch assembly. In turn, this allows the moveable barrier to freely move into a position whereby the striker assembly and the latch assembly are in alignment.

The latch assembly can be operable to retain the striker bolt in the extended position. The latch assembly comprises a keeper having a latch face and a strike face. The keeper can be moveable between a first position and a second position. When the keeper is in the first position the strike face is engageable with the striker bolt to retain the striker bolt in the extended position. That is, the first position of the keeper prevents the striker assembly moving away from alignment with the latch assembly (whereby the striker bolt is able to retract into the striker bolt housing).

In use, when the latch arrangement is actuated, the striker bolt engages the strike face to move the keeper to the second position. This allows the striker bolt to be movable to the retracted position when the striker bolt is out of alignment or substantially out of alignment with the latch assembly.

That is, when the latch arrangement is actuated, the keeper is enabled to move into the second position whereby the striker bolt moves away from alignment with the latch assembly.

In some forms, the keeper assembly may be configured to be mountable to the structure, and the latch assembly may be configured to be mounted to the moveable barrier.

In some forms, the keeper of the latch assembly may be rotatable, between the first and second positions.

In some forms, the latch assembly may further comprise a keeper latch member. The keeper latch member extends between a first end and a second end. The keeper latch member may be rotatable between an engaged position and a released position such that when the keeper latch member is in the engaged position, the second end of the keeper latch member may engage the latch face of the keeper to retain the keeper in the first position and the striker bolt in the extended position.

The keeper latch member can be co-operable with the keeper such that when the keeper is in the first position, the keeper is engaged with the keeper latch member such that keeper can not rotate from the first position. This prevents the striker bolt from rotating the keeper into the second position whereby the moveable barrier could move into the open position.

Advantageously, retaining the striker bolt in the extended position while it is aligned with the latch assembly ensures it will engage the strike face of the keeper, unless the keeper is in the second position.

In some forms, the keeper latch member further comprises a rotatable member provided at the second end. The rotatable member may engage the latch face of the keeper in the engaged position. Advantageously, the rotatable member is able to rotate relative to the latch face so as to minimise resistance between the keeper and the keeper latch member when the keeper latch member rotates between the engaged and released positions.

In some forms, the latch assembly further comprises a second carriage extending between a second carriage first end and a second carriage second end. The second carriage may be moveable between an acting position and a neutral position. When the second carriage is in the acting position, the second carriage causes the keeper latch member to move to the released position. That is, when the second carriage is moved from the neutral position into the acting position, the second carriage moves the keeper latch member to the released position.

In some forms, the second carriage may be slideable between the acting position and the neutral position.

In some forms, the second carriage includes an abutment face that abuts with the first end of the keeper latch member to move, i.e. rotate the keeper latch member to the released position upon the second carriage moving to the acting position.

In some forms, the latch assembly further comprises a biasing member which biases the keeper to the first position. The biasing member may be a torsion spring. In this way, the keeper will move to the first position when the keeper latch member is in the released position, i.e. when the keeper latch member is not engaged with the keeper.

In some forms, the keeper latch member further comprises a biasing member which biases the keeper latch member to the engaged position. The biasing member may be a torsion spring. In this way, the keeper latch member will move into the engaged position when the second carriage is not in the acting position, e.g. when the second carriage is moving to the neutral position.

In some forms, the striker assembly includes a biasing means that is adapted to urge the striker bolt towards the retracted position. In this way the striker assembly doesn't impede the latch assembly when it is moving towards alignment with the striker assembly.

In some forms, the latch assembly further comprises a magnet. The striker bolt may be attracted to the magnet, such that when the latch assembly and the keeper assembly are aligned, a magnetic force between the magnet and the striker bolt causes the striker bolt to move to the extended position. The latch assembly may retain the striker bolt in the extended position such that the latch arrangement is in a latched position. That is, when the keeper is retained in the second position, i.e. engaged with the keeper latch member, the magnetically extended striker bolt (i.e. held in extension by magnetic force) is retained in the latched position by the keeper.

In some forms, the magnet is adapted such that the magnetic force is greater than a biasing force produced by the biasing means so that the striker bolt moves towards the extended position when the latch assembly and the striker assembly are aligned.

In some forms, the latch assembly includes a recess for receiving the striker bolt in the extended position. The recess may be, in part, defined by the strike face of the keeper.

In some forms, the recess may be in juxtaposition or in axial alignment with the magnet.

In some forms, the striker assembly comprises a striker body having an interior surface defining an interior cavity for receiving the striker bolt assembly. The striker bolt assembly may further comprise a striker bolt housing configured to be co-axial with the striker bolt and configured for receiving the striker bolt in the retracted position. That is, the striker bolt housing can be e.g. sized for receiving the striker bolt in the retracted position.

At least a portion of the external surface of the striker bolt housing may be threaded to co-operate in threading engagement to allow the striker bolt assembly to be adjustable relative to the striker body to a selected position to allow alignment of the striker assembly and the latch assembly in latching engagement when the striker bolt is in the extended position.

That is, the threaded co-operation of the striker bolt assembly and the striker body allows for the striker bolt to be moved into a selected, i.e. optimal, position whereby the striker assembly and the latch assembly are aligned when the striker bolt is in the extended position, i.e. when the movable barrier is closed.

In some forms, the latch arrangement may further comprise a lock assembly including a locking member located in the interior cavity of the striker body. The locking member may be moveable between a locked and an unlocked position. When the locking member is in the locked position, the locking member may engage the striker bolt housing to retain the striker bolt housing in the selected position. That is, once the striker bolt assembly and the striker body are aligned (by movement of the striker bolt into e.g. an optimally aligned position) the locking member may be moved to engage and retain the striker bolt housing.

When the locking member is in the unlocked position, the striker bolt housing may be adjustable to a further selected position. That is, the locking member can be unlocked so as to allow the striker bolt housing to be readjusted in position e.g. relative to the striker body.

In some forms, the locking member extends between a first and a second end in a longitudinal direction. The first end may include an inclined surface. The inclined surface may be configured to mate with a corresponding inclined surface formed as part of the interior surface of the striker body. The inclined and the corresponding inclined surface may guide the locking member into the locked and unlocked positions. The second end may include an engagement surface for engaging an abutment surface of the striker bolt housing in the locked position.

In some forms, the lock assembly may further comprise an externally threaded actuator, e.g. a screw, for moving the locking member relative to the striker bolt housing into the locked and the unlocked positions. The locking member may include an internally threaded passage for receiving the externally threaded actuator. Rotational movement of the actuator translates to movement of the locking member in a lateral direction guided by the corresponding inclined surfaces between the locked and the unlocked positions.

That is, as the actuator is screwed into the passage, the locking member is moved in a lateral direction (between the locked and unlocked positions) as guided by the inclined surfaces. Advantageously, this can allow the position of the striker bolt housing to be easily adjusted, e.g. by use of a screw driver, to rotationally operate the threaded actuator to move the locking member between locked and unlocked positions.

In some forms, the striker bolt housing extends between a distal and a proximal end. The distal end may be disposed inside the striker body. The proximal end may include a non-circular end region to allow a tool to grip the end region and rotate the striker bolt housing relative to the striker body to provide the adjustment of the striker bolt housing relative to the striker body to a further selected position.

In some forms, the striker bolt housing may include a flange extending at least, in part, around the proximal end. The non-circular end region may include at least one flat face formed on the flange. In some forms, two opposing, parallel flat faces can be formed on the flange such that e.g. a wrench can be fit to the non-circular end for rotating the striker bolt housing.

In some forms, the striker assembly may further comprise an insert disposed in the striker body. That is, the insert is separate to the striker assembly. At least a section of the external surface of the striker bolt housing may be formed on the insert including the threading for co-operating with the threading of the striker bolt housing. That is, at least a section of the external surface of the striker bolt housing includes threading for co-operating with the threaded insert.

The insert may be insertable into the striker body, and may be configured to retain the striker bolter housing within the striker bolt housing.

According to a third aspect, disclosed is an egress device comprising the latch arrangement as set forth above, the latch arrangement further comprising an actuator assembly. The actuator assembly includes an actuator moveable between a raised position and a depressed position. When in the depressed position, the actuator assembly actuates the latch assembly by engaging the first end of the keeper latch member to move it to the released position to allow the striker bolt to be able to move the keeper to the second position as the moveable barrier is moved towards the open position.

When depressed, the actuator assembly moves the keeper latch member into the released position so that the moveable barrier can be moved towards the open position.

In some forms, the actuator assembly may further comprise an elongate frame extending along a longitudinal axis between a first end and a second end. The actuator may be mounted relative to the elongate frame and operative to be depressable relative to the elongate frame in a transverse direction to the longitudinal axis of the elongate frame to actuate the latch arrangement.

A first carriage may extend between a first carriage first end and a first carriage second end in the elongate frame. The first carriage may be moveable between a driving position and a neutral position. The first carriage may include an engagement face disposed at the first carriage second end to drive the keeper latch member to move to the released position when the first carriage is in the driving position.

In some forms, the engagement face of the first carriage may engage an abutment face of the second carriage, when the first carriage is in the driving position, to cause the second carriage to move into the acting position of the second carriage. As the second carriage moves into the acting position, the second carriage may move the keeper latch member into the released position so as to allow the keeper to move into the second position as the moveable barrier is moved towards the open position.

In some forms, the actuator assembly may further comprise at least one bell crank pivotally connected to the actuator and the first carriage to translate the transverse force transmitted through angular rotation of the bell crank to a force transmitted in the longitudinal direction of the elongate frame towards the engagement face at the first carriage second end and the second end of the elongate frame through depression of the egress bar and initial movement of the movable barrier to an open position.

In the depressed position, the actuator may be positioned close to, e.g. against, the first carriage. In the raised position, the actuator may be positioned away from the first carriage, i.e. spaced away from the first carriage, whereby the raised position is relative to the position of the actuator when in the depressed position.

In some forms, when the actuator is released, the actuator may be biased to the raised position which causes the first carriage and second carriage to move to respective neutral positions, the keeper latch member to rotate to the engaged position, and the keeper to rotate to the first position.

In some forms, the egress assembly may further comprises a remote actuator for allowing the latch assembly to be operated from the other side of the movable barrier. The remote actuator may extend between a first remote actuator end and a second remote actuator end. The first remote actuator end may be configured to be coupled to a remoter driver which causes the remote actuator to rotate. The second remote actuator end may be coupled to the second carriage and may include a cam such that rotation of the remote actuator translates to movement of the second carriage to the acting position which causes movement of the keeper latch member to the released position.

According to a fourth aspect, disclosed is an egress assembly configured to be mountable to a moveable barrier and a structure. The egress assembly can be configured to releasably secure the moveable barrier to the structure.

The egress assembly comprises an actuator arrangement including an actuator moveable between a raised position and a depressed position. When in the depressed position actuator arrangement allows the moveable barrier to move to an open position.

The egress assembly comprises a latch assembly being co-operable with a striker assembly. The striker assembly includes a striker bolt. The latch assembly comprises a strike face for retaining the striker bolt in a latched position when the door is in a closed position. The actuator arrangement can act on the latch assembly to allow release of the movable barrier to be moveable to the open position. That is, the actuator of the actuator assembly can move from the raised to depressed positions so as to allow the moveable barrier to move to an open position.

According to a fifth aspect, disclosed is an egress assembly for a movable barrier comprising an actuator assembly and a latch arrangement. The actuator assembly can be configured to be mounted to an elongate frame extending between a first end and a second end. The actuator arrangement includes an actuator operative to be depressable relative to the elongate frame to actuate, i.e. move, a latch arrangement.

The latch arrangement comprises a latch assembly and a striker assembly. The latch assembly and the striker assembly can be configured to co-operate in latching engagement. The latch assembly can include a magnet and the striker assembly can include a striker bolt that is attracted to the magnet, such that when the latch assembly and the striker assembly are aligned a magnetic force between the magnet and the striker bolt causes the striker bolt to move to an extended position and the latch assembly retains the striker bolt such that the latch arrangement is in a latched position.

The magnetic forces of the magnet act to pull the striker bolt into the extended position, i.e. so that the striker bolt moves into a position closer to the magnet. In this way, when the magnet of the latch assembly and the striker bolt of the striker assembly are aligned, the magnet forces are at maximum to pull, i.e. extend, the striker bolt. In the extended position, i.e. extending from the striker assembly, the striker bolt is in latching engagement with the latch assembly.

The actuator assembly and the latch assembly can be mechanically connected and configured such that depression of the actuator and initial movement of the moveable barrier causes the magnet and striker bolt to move out of alignment which disengages the latch arrangement to allow the moveable barrier to move to the open position.

As the striker bolt is moved, i.e. from the initial movement of the barrier away from the closed position (i.e. to the open position), the space between the striker bolt and the magnet increases such that the magnetic forces acting on the striker bolt become weaker. This results in the striker bolt no longer being held in the extended position.

According to a sixth aspect, disclosed is a striker assembly configured to co-operate with a latch assembly of a latch arrangement when used for an egress assembly. The striker assembly comprises a striker body including an interior surface defining an interior cavity. The striker assembly also comprises a striker bolt housing and a striker bolt. The interior cavity of the striker body houses the striker bolt housing and the striker bolt, the striker bolt housing and the striker bolt can be configured to be co-axial with one another. The striker bolt can be moveable to an extended position such that in the extended position the striker bolt engages with a component of the latch assembly in latching engagement.

At least part of the external surface of the striker bolt housing is threaded to co-operate in threading engagement to allow the striker bolt assembly to be adjustable relative to the striker body to a selected position to facilitate alignment of the striker assembly and the latch assembly in latching engagement. The selected position of the striker bolt assembly may be chosen to ensure that the striker bolt engages with the component of the latch assembly when in the striker bolt is in the extended position.

In some forms, the striker assembly further comprises a lock assembly including a locking member located in the interior cavity of the striker body. The locking member may be moveable between a locked and an unlocked position. When the locking member is in the locked position, the locking member may engage the striker bolt housing to retain the striker bolt housing in the selected position. When the locking member is in the unlocked position, the striker bolt housing may be adjustable to a further selected position.

In some forms, the locking member extends between a first and a second end in a longitudinal direction, the first end including an inclined surface, the inclined surface configured to mate with a corresponding inclined surface is formed as part of the interior surface of the housing, the inclined and the corresponding inclined surface guide the locking member into the locked and unlocked positions, and the second end including an engagement surface for engaging an abutment surface of the striker bolt housing in the locked position.

In some forms, the lock assembly may further comprise an externally threaded actuator, e.g., a screw, for moving the locking member relative to the striker bolt housing into the locked and the unlocked positions. The locking member includes an internally threaded passage for receiving the externally threaded actuator. Rotational movement of the actuator may translate to movement of the locking member in a lateral direction guided by the corresponding inclined surfaces between the locked and the unlocked positions. Movement in the lateral direction may move the locking member into and, out of, engagement, i.e. between unlocked and locked positions, with the striker bolt housing.

In some forms, the striker bolt housing extends between a distal and a proximal end. The distal end may be disposed inside the striker body. The proximal end may include a non-circular end region to allow a tool to grip the end region and rotate the striker bolt housing relative to the striker body to provide the adjustment of the striker bolt housing relative to the striker body to a further selected position.

In some forms, the striker bolt housing may include a flange extending at least, in part, around the proximal end. The non-circular end region includes at least one flat face formed on the flange.

In some forms, the striker assembly may further comprise an insert disposed in the striker body. At least a section of the external surface of the striker bolt housing may be formed on the insert, including the threading, for co-operating with the threading of the striker bolt housing.

### BRIEF DESCRIPTION OF THE DRAWINGS

For illustrative purposes embodiments of the invention will now be described with reference to the accompanying drawings of which:

FIG. 1 is an isometric view of an egress device in a latched condition according to a first embodiment of the present invention;

FIG. 2 is a side view of the egress device of FIG. 1 in a latched condition;

FIG. 3 is a front view of the egress device of FIG. 1 in a latched condition;

FIG. 4 is a sectional view of the egress device through line A-A of FIG. 3 in a latched condition;

FIG. 5 is a detailed sectional view of the egress device in a latched condition and an actuator is in an extended position;

FIG. 6 is a detailed sectional view of the egress device of FIG. 5 in an unlatched condition by retracting the actuator;

FIG. 7 is a detailed sectional view of the egress device of FIG. 6 in an unlatched condition and a striker is being displaced;

FIG. 8 is a detailed sectional view of the egress device in a latched condition and the actuator is in an extended position and the striker is displaced;

FIG. 9 is a detailed sectional view of the egress device of FIG. 5 in the unlatched condition by actuating a second actuator;

FIG. 10 is a detailed sectional view of the egress device of FIG. 9 in an unlatched condition and the striker is being displaced;

FIG. 11 is a perspective view of the actuator assembly and latch assembly mounted to a movable barrier and, wherein a remote actuator is shown in a exploded view configuration;

FIG. 12 is a perspective view of the actuator assembly, latch assembly and remote actuator mounted to the movable barrier;

FIG. 13 is an isometric view of an embodiment of the striker;

FIG. 14 is front view of the striker of FIG. 13;

FIG. 15 is an isometric view of a striker bolt assembly of FIGS. 13; a partial isometric sectional view of the striker along line B-B of FIG. 14;

FIG. 16 is a partial isometric sectional view of a striker bolt assembly with an insert and a locking member;

FIG. 17 is a partial isometric sectional view of the striker of FIG. 16 along line B-B;

FIG. 18 is a sectional side view of the striker along line B-B of FIG. 14 in an unlatched condition;

FIG. 19 is a sectional side view of the striker along line B-B of FIG. 14 in a latched condition;

FIG. 20 is a sectional side view of the striker of FIG. 13 with the locking member in a released position;

FIG. 21 is a sectional side view of the striker of FIG. 20 with the locking member in the release position and the striker bolt assembly extended;

FIG. 22 is a sectional side view of the striker of FIG. 21 with the locking member in a locked position and the striker bolt assembly extended; and

FIG. 23 is a sectional side view of the striker of FIG. 21 in the latched condition.

### DETAILED DESCRIPTION OF THE EMBODIMENTS

The drawings are intended to be schematic, and dimensions, scale and/or angles may not be determined accurately from them unless otherwise stated.

It is understood that, unless otherwise stated, the upward and downward directions refer to the orientation of a latch when mounted onto a substantially vertical surface.

It is understood that, unless otherwise stated, the structure may include a moveable barrier, a gate, a fence, a panel, a post or any other suitable structure for mounting a latch assembly.

It is understood that, unless otherwise stated, the terms bracket, and fixture are intended to have their plain meaning.

It is understood that, unless otherwise stated, the term mount includes temporarily secured, attached, removably fixed and secured, whereby the term is intended to describe one component placed onto another component or body and not limited to the type of fixture used or if the fixture is permanent or temporary.

It is understood that, unless otherwise stated, the term movable barrier includes, for example, a structure, hatch, gate, door, skylight or window, i.e. a member suitable for closing or opening an aperture, but not limited to the pivotal or direction of movement. For example, the member may pivot or slides horizontally and/or vertically.

It is understood that, unless otherwise stated, the terms aligned and/or alignment are not limited to concentric alignment, horizontal alignment, vertical alignment and planar alignment etc.

Although the following detailed description discloses the striker being mounted on a structure in the form of a post and a latch assembly being mounted on a structure in the form of a gate, in alternative embodiments this may be reversed, i.e. the latch assembly may be mounted on the post and the striker may be mounted on the gate.

It is understood that, unless otherwise stated, the term egress means to allow passage from one area to another, where a boundary or perimeter zoning is provided between the two areas. Unless otherwise stated, one area may be a restricted/controlled area and other area may be an unrestricted/uncontrolled area.

It is understood that, unless otherwise stated, the term passageway device means a device to allow passage between two areas, where a boundary or perimeter zoning is provided between the two areas.

The embodiments of egress devices disclosed herein facilitate egress through a moveable barrier. In some circumstances, egress needs to be made in haste. In some embodiments of the egress device disclosed herein, the embodiments of the egress device are configured to permit egress without requiring a high amount of force on the actuator assembly to unlatch the latching mechanism while simultaneously providing a secure and reliable latch arrangement in a closed position.

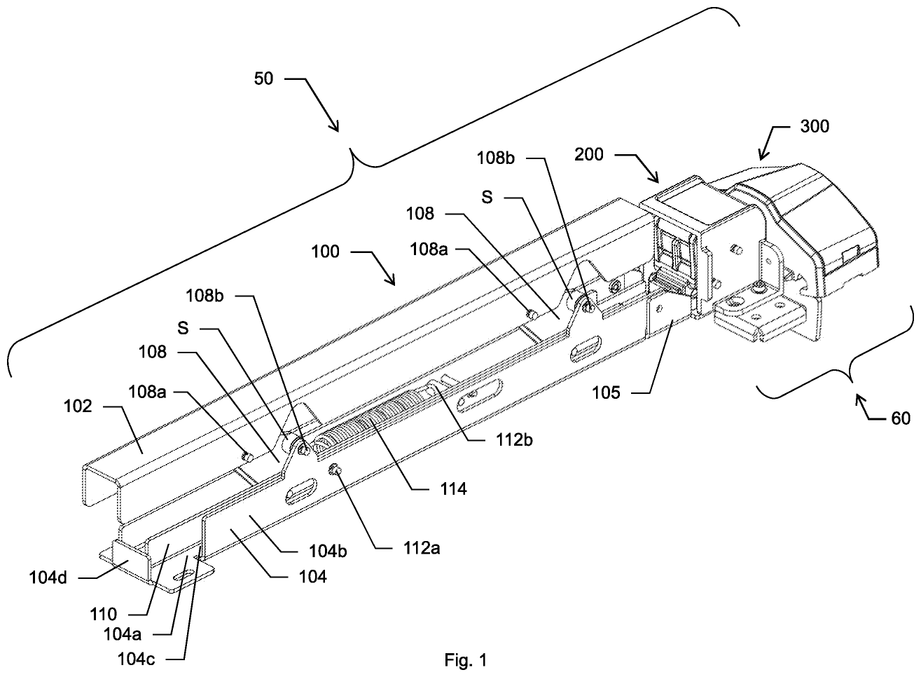

Referring to FIG. 1, an egress device, i.e. an egress bar assembly 50 is shown, comprising an actuator assembly 100 and a latch arrangement 60. The latch arrangement 60 comprises a latch assembly 200 and a striker assembly 300. The actuator assembly 100 and the latch assembly 200 are adapted to be mounted on a movable barrier, e.g. a gate or door, and the striker assembly 300 is adapted to be mounted to a fixed or fixable structure, e.g. gate post or a frame.

The egress device 50 releasably secures the movable barrier to the fixed structure. The striker assembly 300 includes a striker bolt 306 configured to co-operate with the latch assembly 200 in latching engagement. When the latch assembly 200 is brought into proximity of the striker assembly 300, the striker bolt 306 can extend between the striker assembly 300 and the latch assembly 200 to secure the movable barrier with respect to the fixed or fixable structure.

The actuator assembly 100 is operable to release the striker assembly and latch assembly from latching engagement. The actuator assembly comprises an actuator 102, and a first carriage 110 mounted to a first elongate frame portion 104 via a plurality of rockers or bell cranks 108. In the form shown in the present application, the actuator 102 takes the form of a push bar.

The actuator 102 is an elongate member extending between ends, generally along a longitudinal axis. The actuator 102 includes a push surface and two side walls extending from the push surface towards the in-use first carriage 110.

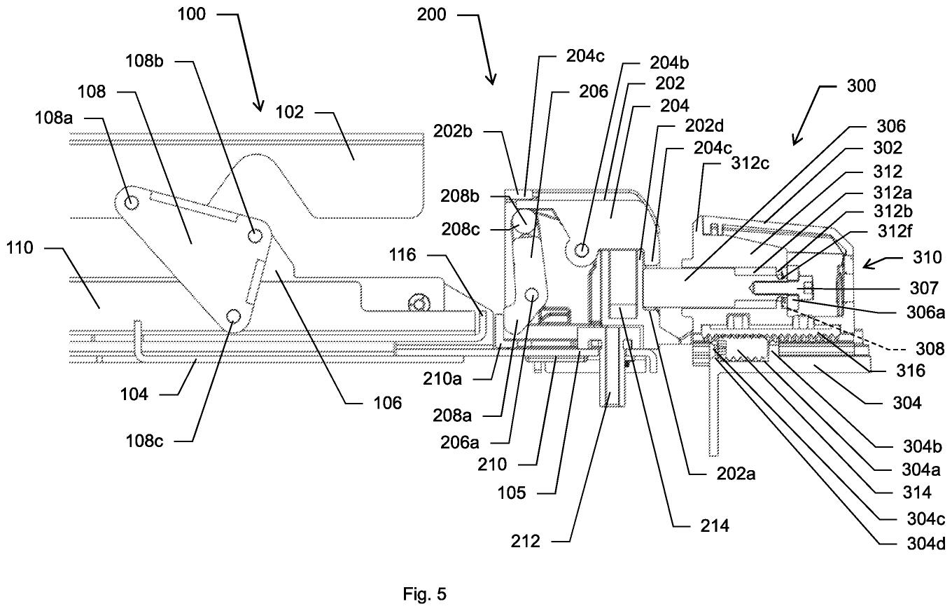

Likewise, the first carriage 110 extends along the same longitudinal axis as the actuator 102 and extends between first and second ends. The first end (i.e. a distal end) of the first carriage 110 is configured to abut the end wall 104d of the first elongate frame portion. The second end (i.e. a proximal end) comprises an engagement flange projecting away from the in-use first frame portion 104. An engagement face 116 of the engagement flange is configured to engage with a second carriage 210 of the latch assembly. As shown in FIG. 5, the engagement face 116 of the second end can be arranged, e.g. formed, perpendicular to the longitudinal length of the first carriage 110, taking the form of a foot. The engagement face 116 provides a surface area for the first carriage 110 to contact, e.g. engage with, the second carriage 210.

Like the actuator and first carriage, the first frame portion 104 also extends between ends generally along a longitudinal axis and comprises a base 104a with upwardly extending side walls 104b. The side walls 104b define a channel 104c therebetween for receiving the first carriage 110. The side walls 104b are spaced from each other such that when the first carriage is received between the side walls 104b, i.e. within the channel 104c, a space, i.e. a clearance, is provided between the side walls 104b and the two side walls of the first carriage 110. The spaced apart side walls 104b of the respective first frame portion 104 and the first carriage 110 allow the first carriage 110 to be displaceable, e.g. slidable, within the channel 104c, without interference, e.g. by frictional contact.

The upwardly extending end wall 104d is provided at a first end of the first frame portion 104 to limit the movement, i.e. sliding movement, of the first carriage 110 with respect to the first frame portion 104. A second end of the first frame portion 104 is configured with respect to a second frame portion 105 of the latch assembly 200 (set forth in more detail later).

The first carriage 110, the actuator 102 and the first frame portion 104 are coupled together by an arrangement of the rockers 108 and pins 112.

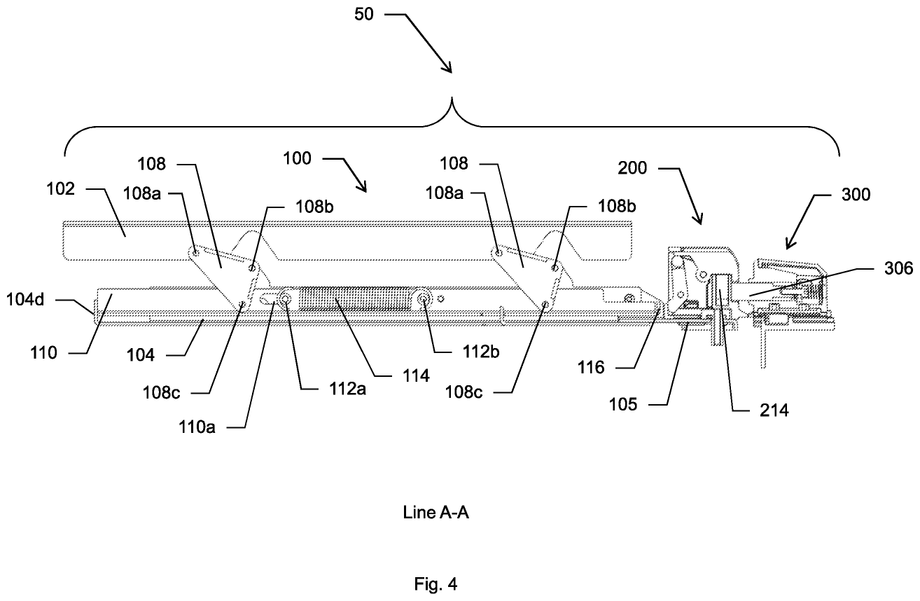

Referring firstly to the first carriage 110 and the first frame portion 104, a first pin 112a is secured to the side walls 104b of the first frame portion 104. As shown in FIG. 4, a central portion of the pin 112a passes through a slot 110a provided in the first carriage 110. Spaced from the first pin 112a, a second pin 112b is secured between the side walls of the first carriage 110. The first and second pins 112a, 112b are connected by a spring 114. The spring 114 biases the first and second pins 112a, 112b toward each other. In the configuration shown, the spring 114 is a tension spring, which enables the bias of the first and second pins towards each other.

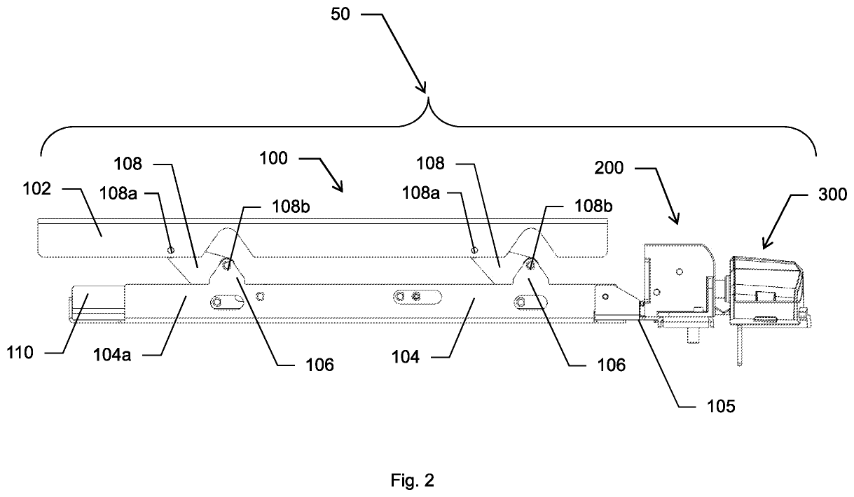

As shown in FIGS. 1, 2 and 4, two rockers 108 are provided to connect the actuator 102 to the first frame portion 104 and the first carriage 110. The two rockers 108 are spaced apart along the length of the actuator 102. While two rockers are shown, it should be understood that more than two rockers can be provided. The rockers are generally triangular in shape, and in the illustrated embodiment, the rockers are in the general shape of a right-angle triangle. The vertices of the triangular rockers are rounded.

A first portion of each rocker 108 is pivotably connected to the actuator 102 by a first pin 108a. A second portion of each rocker 108 is pivotably connected to a flange 106 extending from the side walls 104b of the first frame portion 104 by a second pin 108b. A third portion of each rocker 108 is pivotably connected to the first carriage 110 by a third pin 108c.

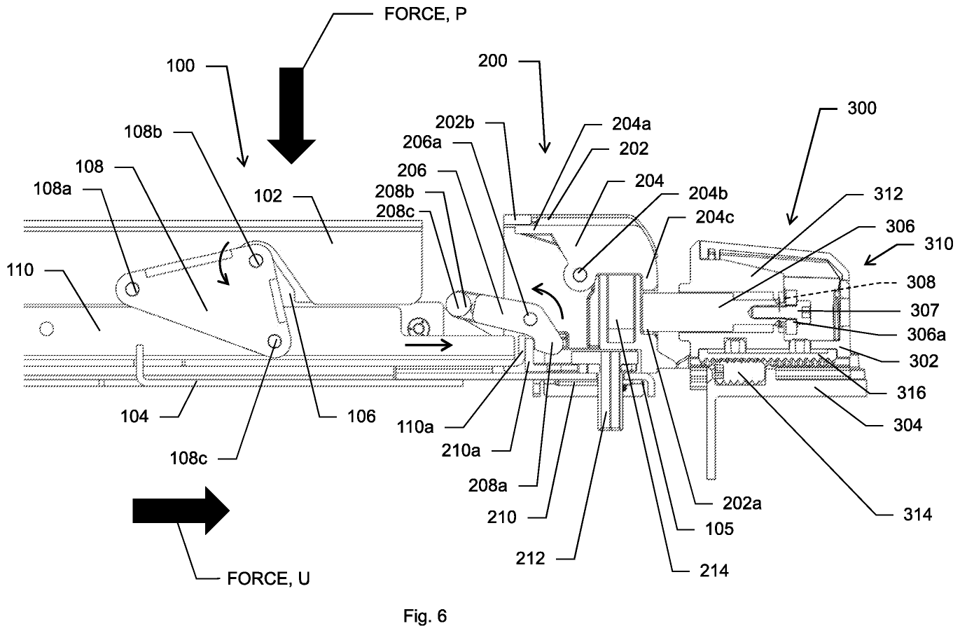

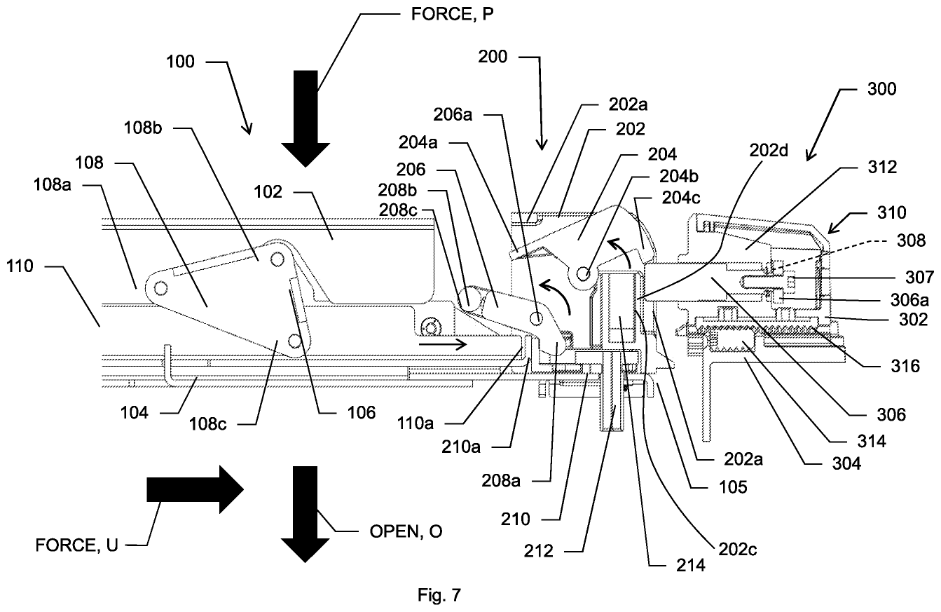

The flange 106 extends from the side walls 104b to complement a corresponding cut-out of the side walls of the actuator 102 (best shown in FIGS. 6 and 7). Advantageously, this allows the pins 108a and 108b to generally align about the longitudinal axis such that the actuator 102 can be positioned (i.e. by pivoting about the rockers 108) proximal to the first frame portion 104. As set forth in more detail later, when the actuator is positioned proximal to the first frame portion, the actuator is considered to be in a depressed position.

In the form shown, the rockers 108 are triangular in shape, whereby the configuration of pins 108a to 108c set forth above are positioned at respective vertices of the rockers 108. The position of the pins 108a, 108b, 108c in each rocker 108 are arranged to magnify the force F of depressing the actuator 102 to a higher transversal force U for displacing the first carriage 110. As shown, the fulcrum of each rocker 108 is around the pin 108b, and by having an increased distance between pins 108a and 108b and between pins 108b and 108c, the magnified transversal force for displacing the first carriage 110 can be achieved. This results in requiring less force to push the actuator 102 during actuation. The pins 108a, 108b, 108c are positioned towards the vertices of the rocker 108. The rockers 108 are mounted inbound, i.e. between the two side walls of the actuator 102. Advantageously, this generally conceals the rockers 108 within the actuator assembly 100 such that movement of the rockers 108 during use is hidden from view.

The rockers 108 allow the actuator 102 to move in a transverse direction (relative to the longitudinal axis of the first frame portion 104). The rockers 108 are arranged so that the actuator 102 remains substantially parallel to the first frame portion 104 during the transverse movement of the actuator 102. In the form best shown in FIG. 1, spacers ‘S’ are provided on the pins 108b (i.e. co-axial with) to space between the rockers 108 and the flanges 106. The spacers ‘S’ can stabilise rotation of the rockers 108, and in turn, parallel movement of the actuator 102 during its use, i.e. actuation.

Referring now to FIG. 5, the latch assembly 200 comprises a latch body 202 for housing and/or supporting components of the latch assembly 200, and a second carriage 210 movably mounted to a second frame portion 105. Contained within the latch body 202 and second frame portion 105 is a keeper latch member 206, a keeper 204 and a magnet 214. Structural features, e.g. ribs, stand-offs, etc., can be formed on an internal wall of the latch body 202 and configured for supporting the keeper latch member 206 and the keeper 204 in their respective locations.

The second carriage 210 comprises and abutment flange projecting away from the in-use second frame portion 105. An abutment face 210a of the abutment flange of the second carriage 210 is arranged to abut the engagement face 116 of the first carriage 110. The engagement face and abutment face 116, 210a allow the second carriage 210 to be displaceable, i.e. slideable, with respect to the second frame portion 105, when the first carriage 110 is displaced with respect to the first frame portion 104. The abutment face 210a is similar in shape to the engagement face 116 of the first carriage 110 in that the abutment face 210a is arranged, e.g. formed, perpendicular to a longitudinal length of the second carriage 210. In this way, the perpendicular engagement face 116 of the first carriage presses against the perpendicular abutment face 201a of the second carriage to displace the second carriage 210 during use.

The abutment face 210a of the second carriage is also arranged for actuating, i.e. moving the keeper latch member 206. The keeper latch member 206 extends between a first end 208a and a second end 208b and is pivotally mounted to the latch body 202 about a pin 206a arranged between the ends 208a,208b.

The keeper latch member 206 is provided with biasing means (not shown) such that the first end 208a is biased to abut an inside face (i.e. opposing the abutment face 210a) of the abutment flange of the second carriage 210. In turn, the biasing means applies a pressure, i.e. biasing force, to hold the second carriage 210 against the first carriage 110.

A rotatable member 208c is provided on the second end 208b of the keeper latch member 206. The biasing means (not shown) of the keeper latch member 206 also biases the rotatable member 208c into engagement with the keeper 204. In this way, the keeper latch member 206 and the keeper 204 are co-operable (as described in more detail below). Further, the biasing means provided on the keeper latch member 206 (i.e. biasing the member 206 about pin 206a) biases the keeper latch member 206 to rotate in a clockwise direction (when viewed through the page).

The keeper 204 includes a latch face 204a and a strike face 204c and is pivotally mounted to the latch body 202 by a pin 204b arranged between the latch and strike faces. The keeper 204 is provided with a biasing means (not shown) such that the strike face 204c is biased to move towards, i.e. to close, an opening of recess 202a in the latch body 202. That is, the keeper 204 is biased to rotate in a clockwise direction.

The keeper latch member 206 is moveable (about pin 206a) between an engaged position (i.e. engaged with the keeper, as per FIG. 5) and a released position (i.e. released from engagement with the keeper, as per FIG. 6). In the engaged position, the keeper latch member 206 is arranged upright, i.e. generally vertical, such that the elongate length of the member 206 is generally perpendicular to the longitudinal length of the first frame portion 104. In the released position, the keeper latch member 206 is generally horizontal in relation to the first frame portion 104.

As shown in FIG. 5, the first end 208a of the keeper latch member 206 is provided with a flat face, being shaped to align with the inside face of the abutment flange 210a when the keeper latch member 206 is upright, i.e. in the engaged position. In another embodiment (not shown), the keeper latch member 206 may be provided with a curved face or a cam face to reduce contact area with the abutment flange 210a so the latch member 206 can be easily actuated as it pivots around the pin 206a when actuated by the abutment face 210a of the second carriage 210.

The keeper 204 is moveable between a first position (i.e. in the position shown in either FIG. 5 or 6) and a second position (i.e. in the position shown in FIG. 7). As shown in FIG. 5 or 6, the keeper 204 can be in the first position when the keeper latch member 206 is in either the engaged or released position.

The strike face 204c of the keeper 204 is shaped such that when the keeper 204 is in the first position, the strike face 204c closes the opening of recess 202a so as to form a closed recess for receiving the striker bolt 306 therein. The closed recess is shown in FIGS. 5 and 6. Conversely, when the keeper 204 is in the second position, strike face 204c is moved away from the opening of the recess 202a such that the recess 202a is opened.

The opened recess 202a is shown in FIG. 7, whereby the keeper 204 in the second position opens a side of the recess distal to the second carriage 210. As set forth in more detail later, the opening in the recess allows for the striker bolt 306 (of the striker assembly 300) to move through, i.e. outwards from, the recess, when positioned therein.

The latch body 202 of the latch assembly 200 further comprises a retaining portion 202c for holding the magnet 214. In the form shown, the retaining portion is a cavity 202c configured to receive the magnet. In alternative forms (not shown), the retaining portion can be an arrangement of upright members spaced to support the magnet 214. In any case, the retaining portion 202c is configured to support the magnet in a fixed position within the latch body 202. The cavity 202c is configured to position, i.e. space, the magnet proximal to, the recess 202a.

The spacing of the magnet with respect to the recess 202a can be chosen to optimise magnetic force applied by the magnet 214 to the striker bolt 306 (i.e. when the striker assembly 200 is brought towards the latch assembly 200). For example, the cavity 202c may position the magnet 214 sufficiently close to the striker bolt 306 such that the striker bolt 306 is attracted towards, and releasably retained at, the recess 202a when the striker assembly 300 is near the recess 202a of the latch assembly 200. In the form shown in FIG. 7, the magnet 214 is spaced by a wall 202d of the latch body.

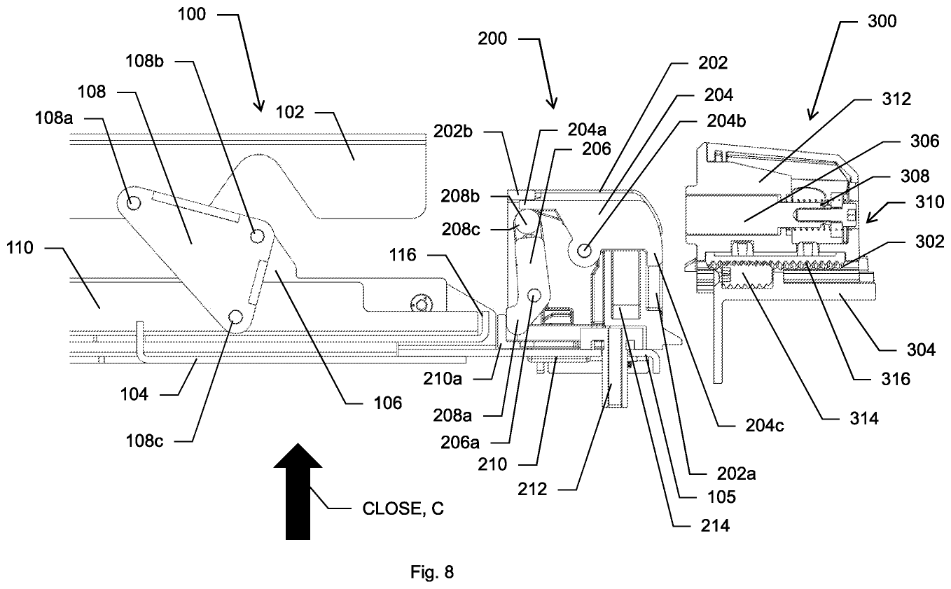

Referring now to the striker assembly 300 as shown in FIGS. 5 to 10. The striker assembly 300 comprises a striker body 302 for receiving therein, a striker bolt housing 312 and a striker bolt assembly 310. The striker bolt assembly 310 includes the striker bolt 306 which is displaceable within the striker bolt housing 312 (i.e. extendable from, and retractable into the striker bolt housing 312). The striker bolt assembly 310 further comprises a biasing means 308 for biasing the striker bolt 306 towards a retracted position (as shown in FIG. 8).

The striker assembly 300 further comprises a mounting bracket 304 for releasably mounting between the striker body 302 and a fixed or fixable structure. As shown, the mounting bracket 304 further comprises a mounting flange 304d that extends perpendicular therefrom to provide additional means for securing the mounting bracket 304 to the fixed or fixable structure.

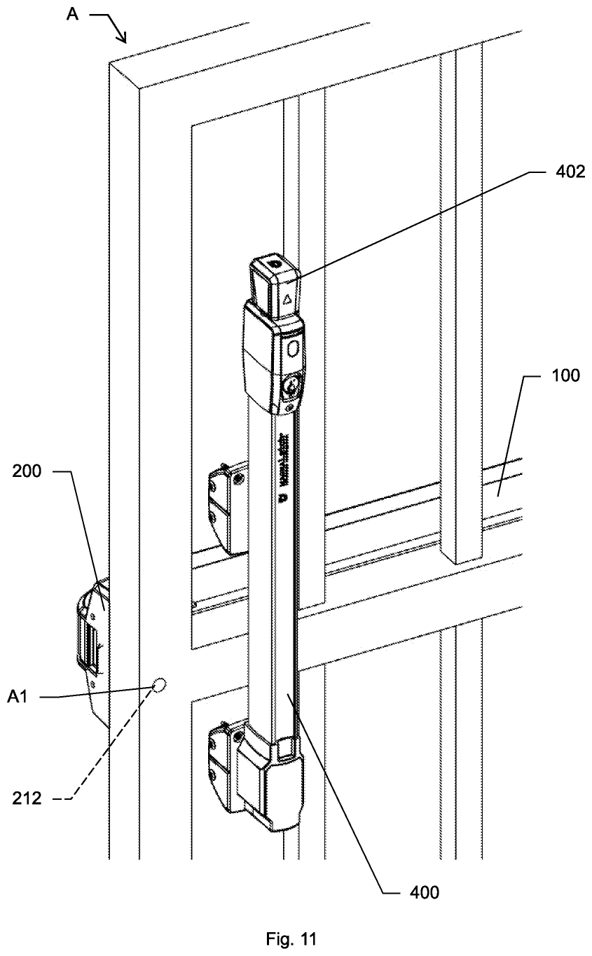

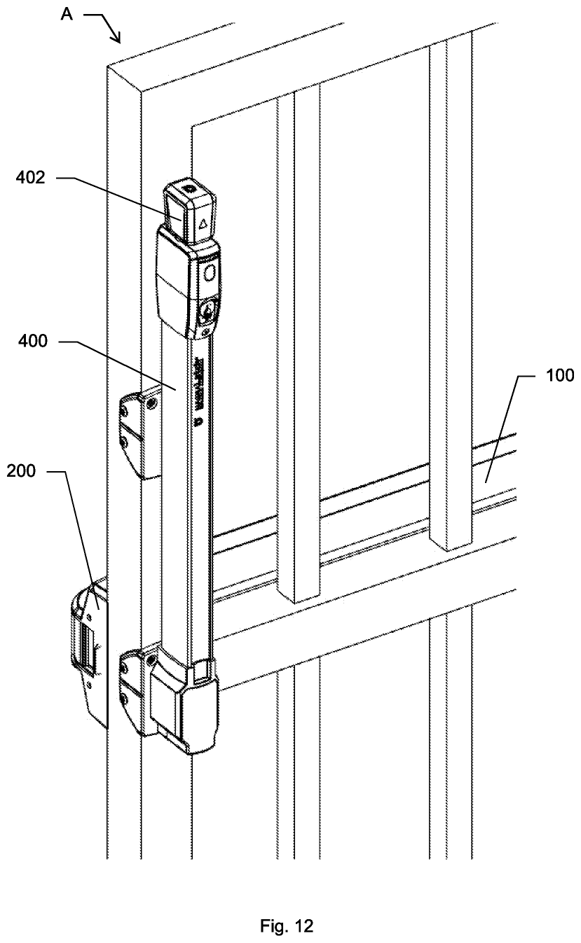

Referring briefly to FIGS. 11 and 12, perspective views are shown of the actuator assembly 100 and latch assembly 200 of the egress device 50 mounted to a movable barrier A. As set forth in more detail below, the striker body 302 can be movably, e.g. slidably, retained with respect to the mounting bracket 304 to vary the gap between the striker assembly 300 and the latch assembly 200.

The striker body 302 and in turn, the striker housing 312, can be movably retained to the mounting bracket 304 about rails (not shown) disposed on the respective striker body 302 and bracket 304. The rails can extend along the elongate length of the respective striker body 302 and bracket 304 and can be slidably engaged with each other such that the striker body 302 can be translated with respect to the bracket 304 along the longitudinal axis of the egress device 50, i.e. parallel to the extension/retraction of the striker bolt 306. A screw 314 and an insert 316 may be used to allow controlled adjustment between the striker body 302 and the bracket 304, which will be described in more detail below.

Referring to FIG. 5, the striker bolt housing 312 includes a bore 312a for receiving the striker bolt 306. The striker bolt housing 312 and bore 312a each extend along the same longitudinal axis as the egress device 50, with each of the striker bolt housing 312 and bore 312a extending between respective proximal and distal ends. The striker bolt 306 extends along the same longitudinal axis as (i.e. to be co-axial with) the bore 312a and the striker bolt housing 312 and comprises proximal 306b and distal ends corresponding with respective ends of the housing 312. In-use, the proximal end 306b of the striker bolt 306 is retained within the bore 312a when the striker bolt 306 is in a retracted position. As shown in FIG. 8, the proximal end 306b is generally aligned with the proximal end of the housing 312 when in the retracted position.

The distal end 306b of the striker bolt 306 is configured to extend through an aperture 312f in the bore 312a to be disposed inside the striker bolt housing 312. The striker bolt 306 is arranged co-axial with the bore such that, in-use, the distal end of the striker bolt 306 can move, e.g., slide, through the aperture 312f from the retracted position, into an extended position. As shown in FIG. 5, in the extended position of the striker bolt 306, the proximal end 306b of the striker bolt 306 protrudes from the bore 312a.

Movement of the striker bolt 306 from, i.e. between, retracted and extended positions can be limited by annular flange 312b and retention member 306a of the respective striker bolt housing 312 and striker bolt assembly 310. The annular flange 312b protrudes from the bore 312a of the striker bolt housing 312 and is configured, i.e. positioned and shaped, to limit travel of the striker bolt 306 in a first direction, i.e. when moving towards the retracted position. The retention member 306a is retained at the distal end 306c of the striker bolt 306 by a fastener 307 and is configured, for example shaped, to abut the striker bolt housing 312 to limit travel of the striker bolt 306 in a second direction, i.e. towards the extended position. This configuration of the flange 312b and the member 306a allows the proximal end 306b of the striker bolt 306 to extend from the housing 312 by a distance set by the spacing between the flange 312b and the in-use member 306a.

The biasing means 308 is arranged on, and co-axial with, the distal end of the striker bolt 306. In-use, the biasing means 308 is located between the striker bolt housing 312 and the retention member 306a. As such, the biasing means 308 biases the striker bolt 306 between ‘hard stop’ points defined by the flange 312b and the member 306a and corresponds to respective retracted and extended positions of the striker bolt 306.

The biasing means 308 can be a compression spring for biasing movement, i.e. displacement, of the striker bolt 306 from the extended position into the retracted position. That is, the compression spring 308 acts to move the proximal end 306b of the striker bolt 306 to reside in the bore 312a. Thus, the compression spring 308 acts against movement of the striker bolt 306 into the extended position. In other words, the striker bolt housing 312 is configured for receiving the striker bolt 306 in the retracted position.

The striker bolt 306 is shown in the extended position in FIG. 5. In FIG. 8, the striker bolt 306 is shown in the retracted position.

The striker body 302 further comprises a flange 302a at its proximal end. The flange 302a is configured to mount a cover 302b about the striker body 302. In the form shown, the cover 302a forms an enclosure around the striker bolt housing 312.

An insert 316 in a form of a rack is secured to the striker body 302. The rack 316 comprises a series of teeth, configured (i.e. by pitch, height, etc.) to correspond with external threads of the screw 314 in the form of a screw. In a further embodiment (not shown), the rack 316 and its teeth may be integral with or formed on the striker body 302.

A recess 304a in the mounting bracket 304 is configured to receive and position the screw 314 with respect to the rack 316. The recess 304a includes a flange 304b for supporting an end of the screw 314. In the form shown, the screw 314 is a worm screw with a tool interface. The flange 304b acts as a dead-stop to prevent the worm screw 314 moving laterally (i.e. in the elongate direction) within the recess 304a.

An aperture 304c is provided in the mounting 304, co-axial with the worm screw 314, for receiving a tool, e.g. a screw driver, therethrough for rotation of the worm screw 314.

The recess 304a in the mounting bracket 304 allows the worm screw 314 to rotate such that the engaged external threads of the worm screw 314 and teeth of the rack 316 are operable move the striker body 302 (and housing 312) relative to the mounting bracket 304. In this way, the corresponding threads and teeth allow the striker body 302 to be adjustable, i.e. by rotation of the worm screw 314, such that the striker body 302 can be moved into a selected position with respect to the bracket 304.

The rack 316 allows the striker body 302 to be moved closer to, or away from, an in-use latch assembly. Thus, rotational movement of the worm screw 314 translates to movement of the striker body 302 in a lateral direction. In effect, the adjustability of the striker body 302 enables the proximal end 306b of the striker bolt 306 to be positioned closer, or further, from the wall 202d of the recess 202a of the latch assembly 200, when the striker bolt 306 is in the extended position. In turn, this allows the proximal end 306b of the striker bolt 306 to be engageable with the strike face 204c such that the striker bolt 306 is securely retained by the latch member 204 in latching engagement.

In some instances, an optimal position of the striker body 302 can be determined by the spacing between the fixed and moveable barriers. The striker body 302 can be adjusted into a position whereby the striker bolt 306 can extend across the space between the barriers and be received within the recess 202a of the latch assembly 200. In this regard, the spacing between the barriers to which the striker bolt 306 extends between, can be referred to as a ‘striking distance’. Thus, the threads of the worm screw 314 and the teeth of the rack 316 allow the striker body 302 to be adjusted to the required, i.e. correct, striking distance.

When the striker body 302 (and in turn, the striker assembly 300) are positioned at the correct striking distance, the striker bolt 306 is engageable with the strike face 204c or recess 202a (i.e. a component of the latch assembly 200) as set forth previously. Thus, the striker body 302 can be adjustable such that when the striker bolt 306 is moved to the extended position (i.e. when proximate to a latch assembly 200), the striker assembly 300 can be in latching engagement with the latch assembly 200.

As described above, the striker body 302 and the striker bolt housing 312 are formed as a unitary component. Alternatively, the striker body 302 and the striker bolt housing 312 may be separate components.

In the latched condition shown in FIG. 5, the striker bolt 306 can be retained in the recess 202a in the extended position when the keeper 204 is held in the first position by the keeper latch member 206 (in the engaged position). When the keeper latch member 206 and the keeper 204 are in these respective positions, the keeper 204 closes the opening of the recess 202a to prevent the striker bolt 306 (and hence, the striker bolt assembly 300) from moving away from engagement with the strike face 204c (and wall 202d) of the latch assembly 200.

In this way, the striker bolt 306 couples the latch assembly 200 to the striker assembly 300 about the recess 202a. When the keeper 204 is in the first position, the strike face 204c can securely engage, i.e. resist movement of, the striker bolt 306 from moving away from magnetised engagement with the latch assembly. Thus, when the keeper 204 is in the first position, the movable barrier can be retained in a closed position (with respect to the fixed structure) by the striker bolt 306.

The latch body 202 further comprises a stopper 202b to restrict rotation of the keeper 204. The stopper 202b is positioned to contact the latch face 204a when the keeper 204 is in the first position. The stopper 202b can support the keeper 204 in the first position so as to provide a clearance between the strike face 204c and the proximal end 306b of the striker bolt 306. That is, the stopper 202b prevents the keeper 204 from over-rotating in a clockwise direction so as to close, i.e. reduce the size of, the recess 202a. Advantageously, this clearance allows the striker bolt to move past the strike face 204c with minimal or no obstruction, as the magnet 214 biases the proximal end 306b of the striker bolt 306 into the recess 202a.

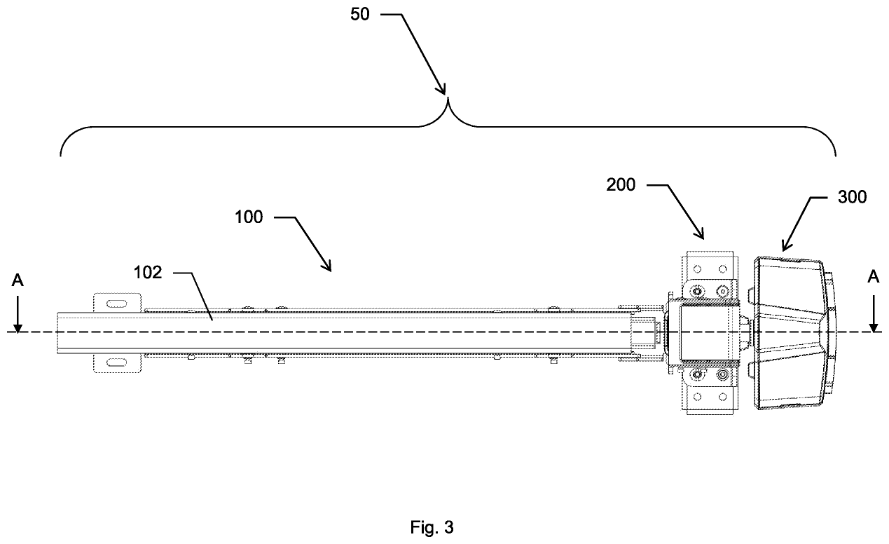

When the keeper 204 is in the first position and the striker bolt 306 is retained by, and engaged with, the latch assembly 200 (i.e. in the extended position), the egress device 50 may be considered to be in a latched condition, whereby the latch and striker assembly 200, 300 are in latching engagement. In this way, when the keeper 204 is in the first position, the strike face 204c is engaged (i.e. secured) with the striker bolt 306 to retain the striker bolt 306 in its extended position (i.e. in latching engagement). The egress device 50 is shown in the latched condition in FIGS. 1 to 5.

As shown in FIG. 5, when the keeper latch member 206 is in the engaged position, the second end 208b of the keeper latch member 206 engages the latch face 204a of the keeper 204 (about rotatable member 208c) to retain the keeper 204 in the first position.

Referring now to FIGS. 6 and 7, when the keeper latch member 206 is moved into the released position, the second end 208b of the keeper latch member 206 (rotates counter-clockwise, and) is disengaged from the latch face 204a of the keeper 204. When the keeper latch member 206 is in the released position, and the keeper 204 is operable to move to the second position, so as to open the recess 202a. This enables the striker bolt 306 to move outwards from the recess 202a, allowing the moveable barrier to be moveable with respect to the fixed structure, such that the moveable barrier can move into an open position.

When the keeper 204 is in the second position and the striker bolt 306 is free to move through the opening of the recess 202a, the egress device 50 may be considered to be in an unlatched condition, whereby the latch and striker assembly 200, 300 are free to move with respect to each other in an unlatched relation. The egress device 50 is shown in the unlatched condition in FIG. 7.

Referring now to the latched condition, i.e. engaged position, of the keeper 204 and keeper latch member 206, as shown in FIG. 5. In the arrangement shown, the latch face 204a is secured between the rotatable member 208c and the stopper 202b such that the latch member 204 is prevented from rotating. This enables the strike face 204c to close the opening to the recess 202a and prevents lateral movement of the striker bolt 306 such that the striker 300 is securely engaged with the latch assembly 200 and is unable to move from the recess 202a.

When in the latched condition, the magnetic force of the magnet 214 applied to the proximal end 306b of striker bolt 306 is greater than the biasing force applied to the striker bolt 306 by the biasing means 308. As such, when the latch assembly 200 is brought into proximity of the striker assembly 300, the magnet 214 magnetically biases the proximal end 306b of the striker bolt 306 to move into the extended position to reside in the recess 202a. In this position, the latch assembly 200 retains the striker bolt 306 in the extended position such that the latch arrangement is in a latched position.

In this regard, the biasing force applied by the magnet is stronger than the biasing force applied by the biasing means, i.e. spring 308. This means that the biasing force of the spring 308 only retracts the striker bolt 306 when the striker assembly is moved away from proximity to the magnet 214. Conversely, when the striker assembly 300 is brought into alignment with the latch assembly 200, the biasing force applied by the magnet moves the striker bolt 306 to the extended position into engagement with the latch assembly 200.

Referring to FIG. 6, the actuator assembly 100 and the latch assembly 200 are mechanically connected such that the latch assembly 200 can be actuated by the actuator assembly 100. The first carriage 110 of the actuator assembly 100 is configured with respect to the actuator 102 to move the second carriage 210. As set forth previously, the first end (i.e. the distal end) of the first carriage 110 abuts the end wall 104d of the first elongate frame portion when the actuator 102 is in its raised position. The engagement face 116 of the second end (i.e. the proximal end) (of the first carriage 110) contact the abutment face 210a of the second carriage to actuate the second carriage 210 of the latch assembly 200.

In the form shown in the present application, the frame portion 104 and second frame portion 105 are separate parts. In some alternative forms (not shown) the first and second portions may be formed from a single part, i.e. a single portion extends between the actuator assembly 100 and the latch assembly 200.

Actuation of the second carriage 210 displaces, e.g., slides, the second carriage with respect to the second frame portion 105 between acting and neutral positions. Referring firstly to FIG. 5, the first carriage 110 and second carriage 210 are shown in respective neutral positions. Referring then to FIG. 6, as the first carriage displaces the second carriage during actuation of the actuator 102, the second carriage is displaced, e.g., moved into an acting position, whereby the keeper latch member 206 is also moved (e.g., rotated) into to the released position by engagement with the second carriage.

When the keeper latch member 206 is in the released position, the striker bolt 306 is able to movably engage the strike face 204c to move the keeper 204 to the second position (i.e. to open the recess 202a). This allows the striker bolt 206 to move from the recess, to in turn move the proximal end 306b of the striker bolt 306 away from the magnet 214. This moves the striker bolt 306 out of alignment with the magnet, or substantially out of alignment with the latch assembly 200, such that the striker bolt can move (from its extended position) to a retracted position.

The actuator assembly 100 acts on the latch assembly to release the movable barrier into the open, unlatched position. This process is illustrated in the sequence of FIGS. 5 to 8, where firstly, the egress device 50 is shown in FIG. 5 in the latched condition, the actuator 102 being in the raised position. By comparison, FIG. 6 shows the egress device 50 in the unlatched condition where the actuator 102 is in the depressed position when a force P is applied to the actuator 102.

As the force P is applied to the actuator 102, the force P is translated into the first pin 108a to cause the rockers 108 to rotate about, i.e. around, the respective second pin 108b. Simultaneously, the rotation of the rockers 108 exerts a force U on the respective third pin 108c and causes the first carriage 110 to be displaced, i.e. moved from the neutral position.

Application of the force, P results in the depression of the actuator 102 along a first direction, i.e. path of travel indicated by force P (i.e. acting transverse to the longitudinal axis of the elongate frame). The corresponding rotation of the rockers 108 translates the force, P through angular rotation to move the first carriage 110 along a second direction, i.e. path of travel transverse to the first direction.

As the first carriage 110 moves along the second direction, the first carriage 110 moves into a driving position, whereby the engagement face 116 of the first carriage 104 actuates, i.e. engages the corresponding abutment face 210a of the second carriage 210. This causes the second carriage to displace, i.e. move, from the neutral position to the acting position. In turn this forces the keeper latch member 206 to rotate against its bias (as set forth above, but not shown) so as to disengage, i.e. move, the rotatable member 208c from the latch face 204a. At this point of the actuation, the latch face 204a is no longer secured between the rotatable member 208c and the stopper 202b.

As the keeper latch member 206 is moved into the released position, the biasing means of the keeper 204 (as set forth above, but not shown) maintains a bias on the strike face 204c to close the opening to the recess 202a. As set forth previously, and as shown in FIGS. 5 and 6, this allows the keeper 204 to be in the first position when the keeper latch member 206 is in either the engaged or released position.

Referring to FIG. 7, once the keeper latch member 206 is in the released position and the keeper 204 unrestrained by the keeper latch member 206, the striker bolt 306 can engage the strike face 204c to force the keeper 204 to rotate against its biasing means. As the keeper 204 rotates into the second position, the strike face 204c no longer closes the opening to the recess 202a. This enables the striker bolt 306 to pass through the opening of the recess 202a upon initial movement of the movable barrier. In this arrangement, the egress device 50 is in the unlatched condition, whereby the latch assembly 200 can be laterally displaced with respect to the keeper 204 to allow the movable barrier to open in the direction of the force P.

In some forms, the actuator 102 can be configured such that movement from its raised position, into a partially depressed position, moves the keeper latch member 206 into the released position. Further depression of the actuator 102 from the partially depressed position into a depressed position enables the striker bolt 306 to engage the strike face 204c to move the keeper 204 to the second position. This configuration (i.e. including movement through a partial depression stage) differs from the alternative form, set forth above, whereby the actuator 102 is configured to move between fully raised and fully depressed positions (for corresponding movement of the keeper 204 between first and second positions).

Referring now to FIG. 8, when the force P is removed from the actuator 102, so as to release the actuator 102, the actuator 102 is biased into the raised position in the direction of the arrow indicated at ‘Close, C’. As set forth previously, the spring 114 acts to bias the first carriage 110 with respect to the frame portion 104, such that when the actuator 102 is in the depressed position, the first and second pins 112a, 112b are spaced further apart (than when the actuator is in the raised position) so that the spring 114 is extended. This biases the spring 114, such that the spring acts to bias the actuator 102 into the raised position. In turn, this causes the first carriage 110 and second carriage 210 to move to respective neutral positions.

As the first and second carriages move away from their respective driving and active positions, the keeper latch member 206 rotates (as a result of its bias) into the engaged position. As set forth previously, the keeper 204 is also biased such that, without forced rotation by the striker bolt moving from the recess 202a, the keeper remains in the first position. As such, once the actuator 102 is released and the keeper latch member 206 returns to the engaged position, the keeper 204 is engaged, i.e. secured by the latch member 206 in the first position.

When the actuator 102 is in the raised position, the spacing, i.e. location of the actuator 102 with respect to the first carriage 110 is determined by the size and position of the slot 110a. In other words, the protrusion of the actuator is determined by the slot 110a. As best shown in FIG. 4, the slot 110a provided in the side walls of the first carriage 110 is sized and positioned to limit the amount of travel of the first carriage 110 with respect to the first frame portion 104. For example, the length of the slot 110a can control the spacing of the actuator 102 from the first carriage 110 when in the raised position.

As shown in FIG. 8, once the actuator 102 has been released to the raised position and the latch assembly 200 has been moved away from the striker assembly 300 (i.e. unlatched), the striker bolt 306 is no longer in proximity of the magnet 214. In this position, the magnetic force applied to the proximal end 306b of the striker bolt 306 is weakened such that the biasing means 308 of the striker assembly 300 biases the striker bolt 306 into its retracted position. In the retracted position, the proximal end 306b of the bolt 306 no longer protrudes beyond the striker bolt housing 312.

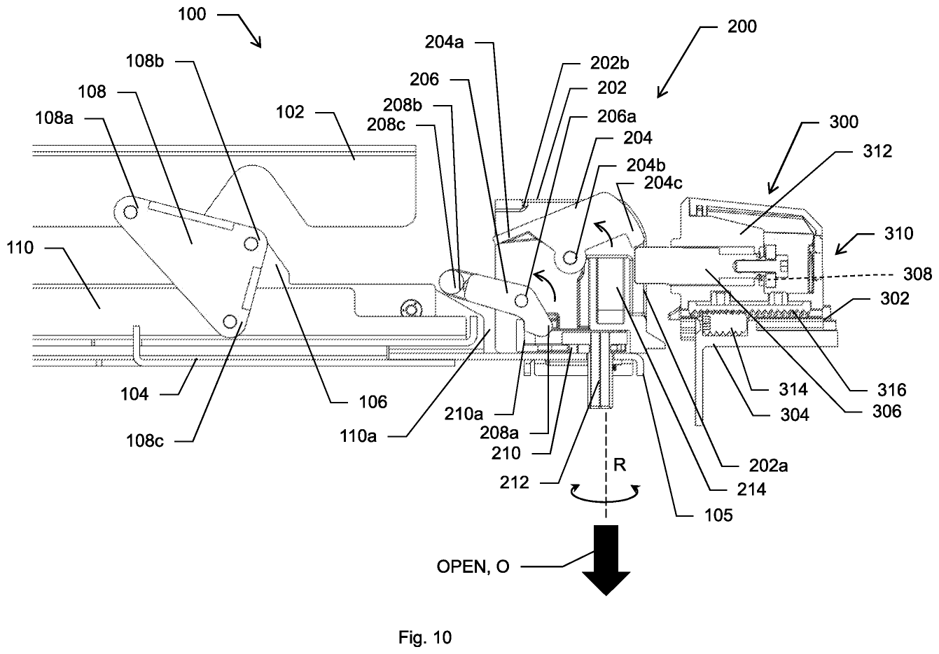

It is apparent when comparing FIGS. 5 and 10 that, as the movable barrier closes and the latch assembly 200 is brought into proximity with the striker assembly 300, the magnet 214 biases the head of the striker bolt 306 to extend into the recess 202a. In this way, the latch assembly 200 co-operates with the striker assembly 200 to engage the respective components in latching engagement.

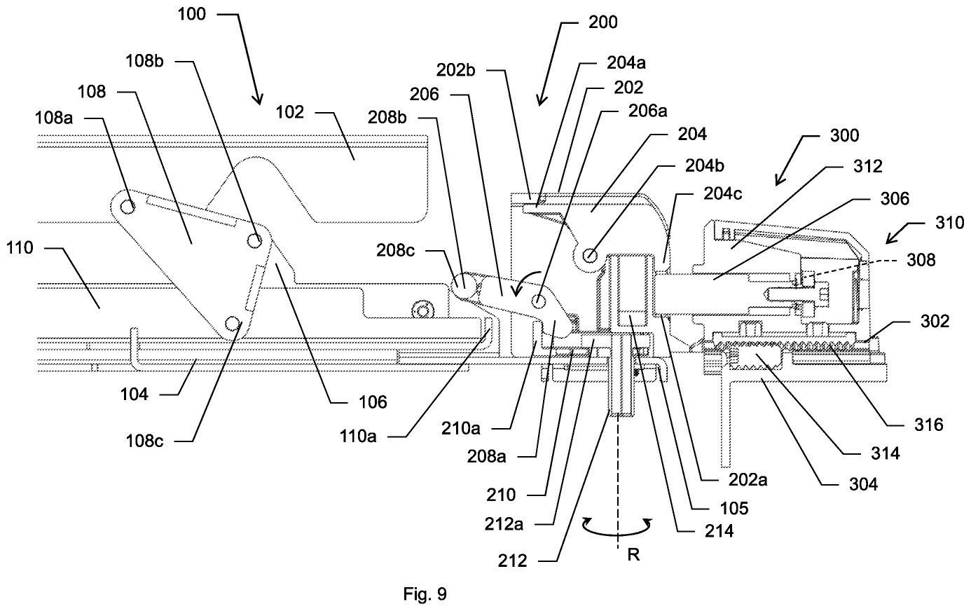

Referring now to FIG. 9, the latch assembly 200 further comprises a remote actuator 212 coupled to the second carriage 210. The remote actuator 200 can be used for displacing the second carriage 210 with respect to the second frame portion 105, between the acting and neutral positions. In effect, the remote actuator is operable to move the keeper latch member 206 between the engaged position and the released position. In this way, the remote actuator can bypass the actuator assembly 100 to operate the latch assembly 200.

The latch assembly 200 can be operated by the remote actuator 212 for allowing the egress device 50 to be operated from a remote side of the movable barrier. In the form shown in FIG. 9, the remote actuator is positioned on an opposite side to the latch assembly 200 with respect to the second frame portion 105. In other forms not shown, the remote actuator may be configured to operate from an alternative position on the egress device 50.

The remote actuator 212 may be coupled to a remote driver at a first end 212b of the remote actuator 212. While the remote driver is not shown in FIG. 9 or 10, an example of the remote driver 400 is shown in FIGS. 11 and 12. The remote actuator 212 is operable by the remote driver to enable the keeper 204 to be retained in the first position, i.e. when the keeper latch member 206 is engaged with the keeper 204. Alternatively, the driver is operable to enable the keeper 204 to be moved from the first position into the second position, when the keeper latch member 206 is disengaged from the keeper 204, i.e. to release the keeper 204. That is, the keeper 204 is moved into the second position by the striker bolt 306 as the movable barrier opens.

The remote actuator 212 is configured to be coupled to the second carriage 210 about a second end of the remote actuator 212. As shown, the second end of the remote actuator 212 comprises a cam 212a (shown in side-section view). When the remote actuator 212 is rotated R, the rotational motion of the remote actuator 212 is translated, by the cam 212a into linear movement of the second carriage 201a. This linear movement causes actuation of the second carriage 210 and moves the second carriage into the acting position. In this regard, the cam 212a is mechanically connected to the second carriage 210 for controlling movement of the second carriage between neutral and active positions.

As the second carriage is moved into the acting position by the remote actuator, the abutment face 210a also moves to contact and, thereby, rotate (in this case, by pulling movement of the abutment face 201a against) the keeper latch member 206. In effect, the rotatable member 208c also rotates with the rotation of the keeper latch member 206. As the abutment face 210a of the second carriage contacts the first end of the keeper latch member 206 to rotate the keeper latch member 206 away from engagement with the keeper 204, the keeper 204 is released for movement into the second position. In this way, the latch face 204a is no longer secured between the rotatable member 208c and the stopper 202b. In this arrangement, the biasing means of the keeper 204 maintains bias on the strike face 204c so as to close the opening to the recess 202a once the striker bolt 306 is moved away from the latch assembly.

Referring now to FIG. 10, once the keeper 204 is released from the first position and no longer engaged with the keeper latch member, application of an opening force O on the remote actuator 212 allows the striker bolt 306 to engage the strike face 204c to rotate the keeper 204 against its biasing means. As the keeper 204 rotates, the strike face 204c no longer closes the opening to the recess 202a, and this enables the striker bolt 306 to pass through the opening of the recess 202a. In effect, the latch assembly 200 is laterally displaced with respect to the striker assembly 300, allowing the movable barrier to open in the direction of the opening force O.

Whilst the embodiment shown in FIGS. 9 and 10 disclose the remote actuator 212 as being rotatably operated, it is anticipated that the remote actuator 212 may be linearly operated. For example, the remote actuator may be configured such that depression of the remote actuator unlatches the latch assembly 200 (as set forth previously). In this way, it is anticipated that the remote actuator 212 may be operated in a linear path that is transverse to the displacement path of the second carriage 210.

Referring now to FIG. 12, a passageway device is shown, comprising the actuator assembly 100, latch assembly 200 and remote actuator 400 of the egress device 50, mounted to a movable barrier A. The remote driver 400 is mounted on an opposite side of the moveable barrier A to the latch assembly 200. Although not shown, it can be envisaged that the striker assembly 300 is mounted to a fixed structure and can be aligned with the latch assembly 200 to secure the movable barrier A in a closed position when the movable structure is brought towards the fixed structure. In this case, the fixed and movable structures can be secured together when the egress device 50 is in a latched condition, i.e. when the keeper latch member 206 is in the engaged position with the keeper 204 in the first position.

FIG. 11 shows a similar arrangement to FIG. 12, differing in that FIG. 12 is a partially exploded view, whereby the remote driver 400 is in an offset position (relative to the mounted position shown in FIG. 12). An aperture A1 is provided in the movable barrier A to allow the remote actuator 212 of the actuator assembly 200 to be coupled with the remote driver 400.

The remote driver 400 comprises a release mechanism 402 operational to actuate, e.g. by rotation or linear depression, the remote actuator 212 of the latch assembly 200. As shown, the release mechanism 402 of the remote driver 400 is positioned higher than the actuator assembly 100, e.g. proximal to a top of the moveable barrier A.

The higher position of the release mechanism is advantageous for safety applications where entry to a fenced or confined area is restricted but the egress can be unrestricted. This may be particularly advantageous for barriers for swimming pools, where local regulations require the height of the release mechanism 402 on access gates to swimming pools to be placed at a minimum height above ground level to prevent young children from operating the mechanism 402 and gaining access to the swimming pool area. The egress device 50, which is positioned relatively lower, would allow younger children to exit the swimming pool area. To prevent younger children from operating the egress device 50 from the other side of the boundary, a shielding (not shown) may be provided.

In alternative embodiments, the remote driver 400 of FIG. 12 may be replaced by an electronic or mechanical keypad actuator kit, RFID actuator kit, a wireless actuator kit, electronic actuator kit, electro-mechanical actuator kit or other mechanical actuator kit.

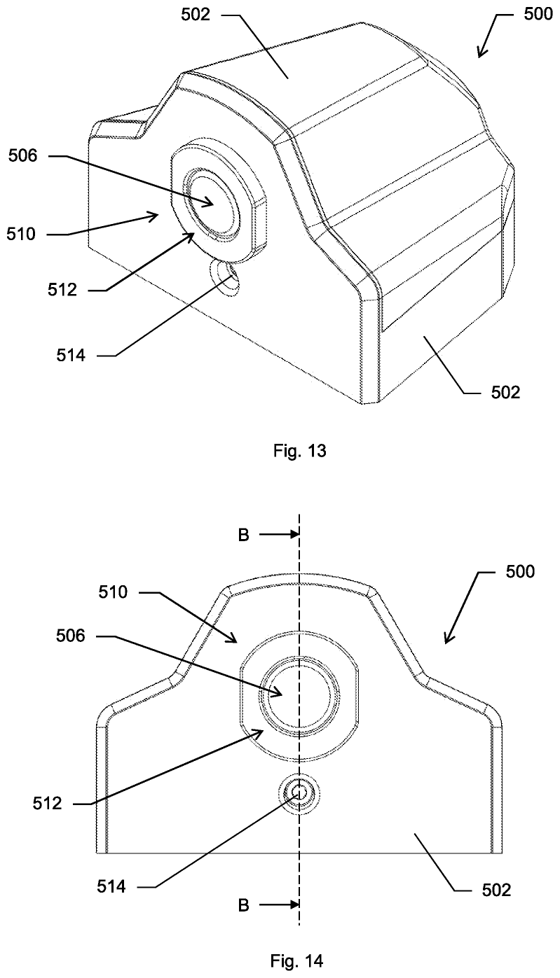

Referring now to FIGS. 13 to 23, an alternative embodiment of the striker assembly 500 is shown. The striker assembly 500 comprises a striker body 502 configured to receive a striker bolt assembly 510. The striker bolt assembly 510 is secured to the striker body 502 about an insert 516, configured to be received in an interior cavity 502a defined by an interior surface of the body 502.

The striker assembly 500 is similar to the striker assembly 300 set forth previously, differing primarily in that the striker body 502 and the striker bolt housing 512 are separate components, whereby the striker bolt 506 and the striker bolt housing 512 forms a striker bolt assembly 510 configured to be adjustable in position with respect to the striker body 502. This enables the striker bolt 506 to be positioned closer, or further, from the recess 202a of the latch assembly 200, when the striker bolt 506 is in the extended position. In a similar way to the embodiment of the striker assembly 300 (shown in FIGS. 4 to 10), this further embodiment of the striker assembly 500 also allows the striker bolt assembly 510 to be optimally positioned for allowing the proximal end 506b of the striker bolt 506 to be received in the recess 202a of the latch assembly 200 (against wall 202d) when in the extended position. In turn, this allows the proximal end of the striker bolt 506 to be engageable with the strike face 204c such that, when in the latch and striker assemblies are in the latched condition, the striker bolt 506 is securely retained by the keeper 204.

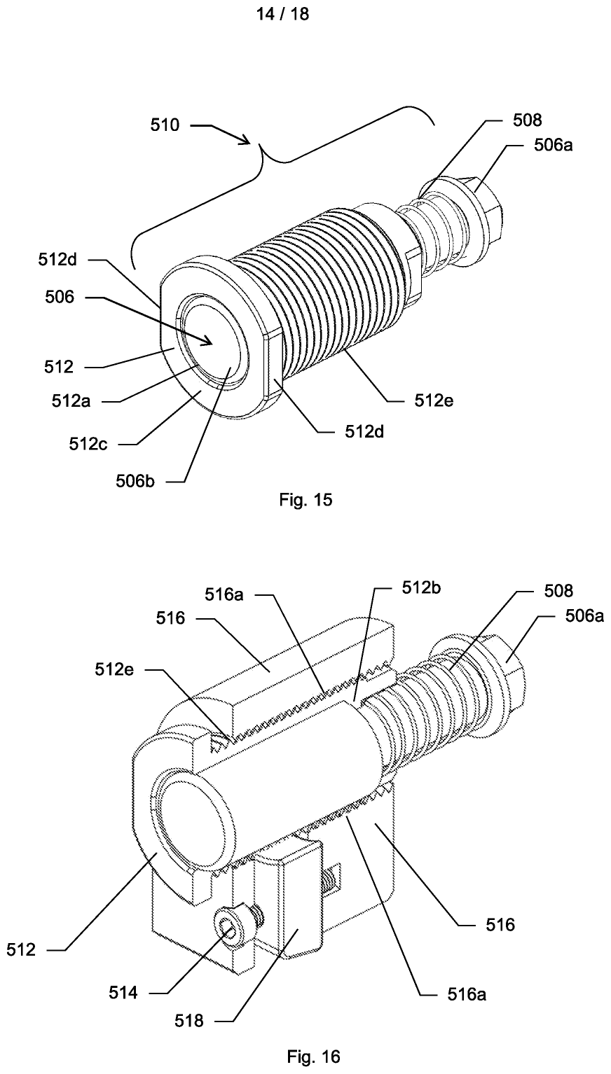

Referring now to FIG. 15, the striker bolt assembly 510 comprises said striker bolt housing 512 having a bore 512a for housing the proximal end 506b of the striker bolt 506 (when the striker bolt 506 is retracted). The striker bolt housing 512 extends along the same longitudinal axis (i.e. co-axial) as the striker bolt 506 and extends between proximal and distal ends. In-use, the proximal end of the housing 512 generally aligns with the proximal end 506b of the striker bolt 506 (when in a retracted position). The distal end of the striker bolt housing 512 is disposed inside the striker body 502.

An annular flange 512b is provided within the bore 512a to limit the travel of the striker bolt 506 in a first direction, i.e. away from an in-use latch assembly 200. A retention member 506a, i.e. a nut, is provided on a distal end of the striker bolt 506 for abutting the housing 512 to limit travel of the striker bolt 506 in a second direction, i.e. towards an in-use latch assembly 200. In-use, the biasing means 508 is arranged on, and co-axial with, the striker bolt 506, between the annular flange 512b and the retention member 506a.

The biasing means 508 therefore biases movement, i.e. displacement, of the striker bolt between ‘hard-stop’ points defined by the flange 512b and the member 506a. In effect, this biases the proximal end 506b of the striker bolt 506 to reside within the bore 512a (i.e. when in the retracted position). Further, this allows the striker bolt 506 to extend from the housing 512 by a distance set by the spacing between the flange 512b and the member 506a. In this way, the striker bolt housing 512 is configured for receiving the striker bolt 506 in the retracted position.

The housing 512 further comprises a flange 512c at the proximal end. The flange is configured with a pair of parallel flat faces 512d (i.e. configured as a non-circular end). As shown, the flange 512c extends between the pair of parallel flat faces, i.e. so as to extend at least in part around the proximal end. The pair of parallel flat faces 512d provide a gripping surface for a tool, e.g. a wrench, to hold and rotate the striker bolt assembly 510 with respect to the striker body 512.

The housing 512 further comprises an external thread 512e disposed on a central portion of the housing 512, i.e. between proximal and distal ends. The thread 512e is configured (i.e. by pitch, diameter, etc.) to correspond with a mating threaded bore 516a of the insert 516. In this way, at least a section of the external surface of the striker bolt housing 512 is formed (i.e. separately formed) on the insert 516. The threaded bore 516a is configured for receiving the striker bolt assembly 510 whereby the external thread 512e of the housing 512 engages with the threaded bore 516a. As set forth below, the external thread 512e of the housing can be used together with the threaded bore 516a to move the striker bolt assembly 510 into a selected position.

The corresponding threads 512e, 516a allow the striker bolt assembly 510 to be adjustable, i.e. by rotation relative to the striker body 502, such that the striker bolt assembly 510 can be moved into a selected position with respect to the striker body 502. The selected position is chosen to align the striker assembly 500 and the latch assembly 200 when the striker bolt 506 is in the extended position. In other words, the selected position of the striker bolt assembly 510 can laterally align the proximal end 506b of the striker bolt 506 with the wall 202d of the recess when the striker bolt 506 is in the extended position.

The external thread 512e on the housing 512 allows the striker bolt assembly 510 to be moved closer to, or away from an in-use latch assembly 200. In this way, the thread 512e allows the striker bolt assembly 510 to be adjusted (into an optimal position) so that the striker assembly 500 and the latch assembly 200 can be in latching engagement.

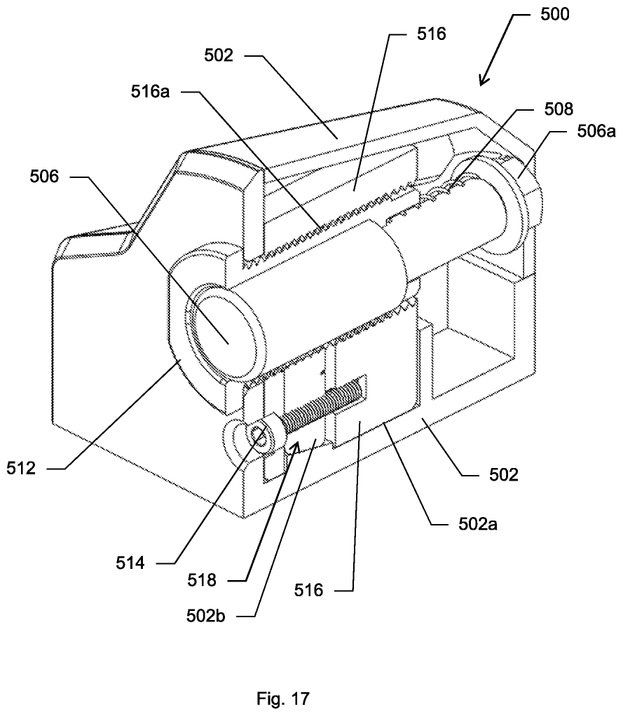

As shown in FIGS. 16 and 17, the striker bolt assembly 510 is secured with respect to the insert 516 by a locking member 518. As shown, the locking member 518 extends between a first and a second end in a transverse direction to a longitudinal (i.e. elongate) extent of the insert 516. In-use, the first side of the locking member 518 at an interior surface of (i.e. adjacent to) the interior cavity 502a of the striker body 502. The second end of the locking member 512 is arranged (as set forth below) adjacent to the in-use striker bolt housing 512.

The locking member 518 is located in the interior cavity 502a of the striker body 502 and in the form shown, the locking member 518 resides in a cavity provided in the insert 516. The insert 516 also resides in the cavity 502a, such that the combination of the insert 516 and locking member 518 secures the striker bolt assembly 510 to the striker assembly 500.

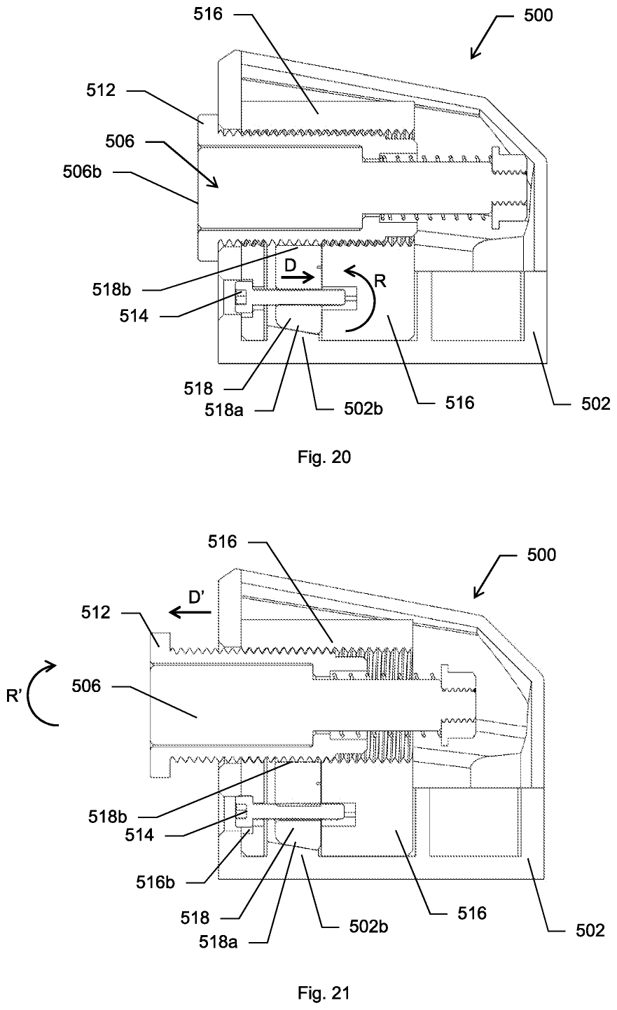

Referring now to FIGS. 20 and 21, the first end of the locking member 518 comprises an inclined surface 518a for mating with a corresponding inclined surface 502b on the interior cavity 502a of the striker body 502. In the form shown, the corresponding inclined surface 502b of the striker body 502 is formed as part of, i.e. to be continuous with, the interior surface of the striker body 502. In other forms not shown, the corresponding inclined surface 502b may be separately formed to the body 502, e.g. formed as part of a separate base for assembly with (i.e. as part of) the body.

The second end of the locking member 518 includes an engagement surface 518b for engaging with an abutment surface of the striker bolt housing 512 when in a locked position. In the form shown, the abutment surface is the external thread 512e of the striker bolt housing 512. The inclined surface 518a and the corresponding inclined surface 502b are able to guide the locking member 518 from (i.e. between) the locked position to an unlocked position, as set forth in more detail, below.

An externally threaded actuator in the form of a screw 514 is provided to move the locking member 518 relative to the striker bolt housing 512. An internally threaded passage is provided in the locking member 518 and is configured to receive, and engage with, the screw 514. A corresponding aperture 516b is provided in the insert 516 and in-use, is aligned with the internally threaded passage for receiving the screw 514 therethrough. The aperture 516b includes a shoulder for supporting a head of the screw 514. The aperture is sized (i.e. diametrically) to at least allow a shaft of the screw 514 to be received therethrough without interference. The shoulder is sized to support the head of the screw 514 such that when the screw 514 engages with the internally threaded passage of the locking member 518, the head is retained by the shoulder. This configuration allows the screw 514 to freely rotate within the aperture 516b while the threaded portion of the screw 514 engages with the threaded passage of the locking member 518.

The internally threaded passage allows the screw 514 to move the locking member 518 relative to the striker bolt housing 512 between the locked and the unlocked positions. In the form shown, the screw 514 moves the locking member 518 with respect to the insert 516 to enable a further movement of the locking member 518 (i.e. towards and away from the housing 512) between the locked and unlocked positions.

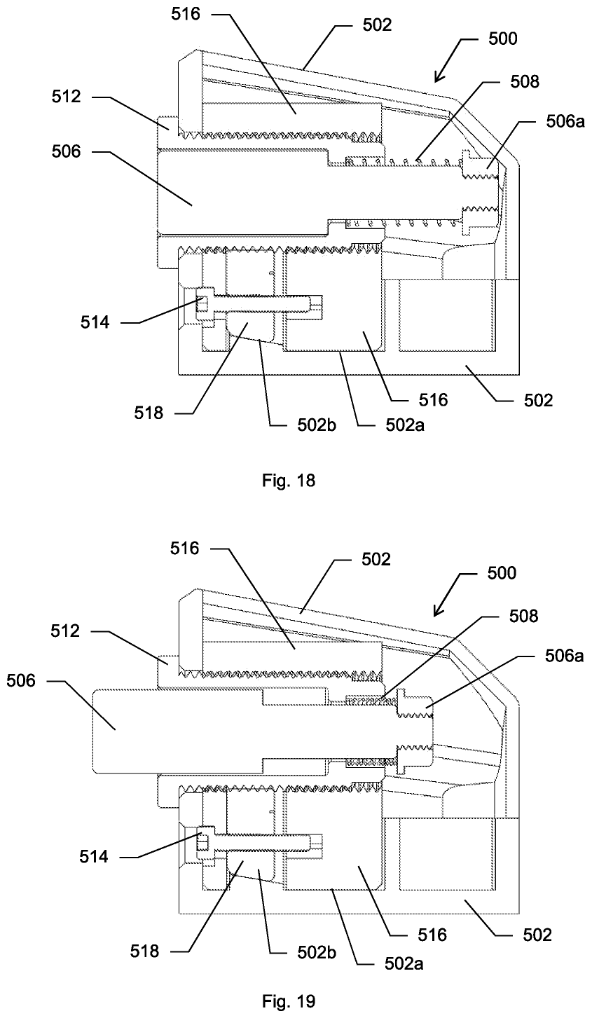

FIGS. 20 to 22 illustrate the steps of adjusting the position of the striker bolt assembly 510 with respect to the insert 516 and housing 502. Before the striker bolt assembly 510 can be adjusted in position (i.e. in direction D indicated by FIG. 21), the engagement surface 518b of the locking member 518 needs to be disengaged from the external thread 512e of the housing 512 by rotating the screw 514. This initial position of the locking member, i.e. where the engagement surface 518b is engaged with the external thread 512e, is shown in FIG. 18.

The arrangement of the striker assembly shown in FIG. 18 may be provided for packaging and transportation, e.g. shipping, of the assembly prior to installation on e.g. a fence. In this arrangement, the engagement surface 518b of the locking member 518 is shown in an engaged position with the external thread 512e of the housing 512 so as to secure, e.g., lock, the striker bolt in a fixed position.

Referring now to FIG. 20, as the screw 514 is rotated R, the locking member 518 moves down the inclined surface 502b (from the locked position to the unlocked position) in the direction indicated by D. This movement displaces the locking member 518 away from the thread 512e, thereby releasing the engagement surface 518b from the external thread 512e. In this way, the rotational movement of the screw 514 translates to movement of the locking member 518 in a lateral direction, i.e. in the direction of the longitudinal axis.

Once the locking member 518 is released, the striker bolt assembly 510 can be rotated R′, as indicated in FIG. 21. As set forth previously, this may be achieved by securing the pair of parallel flat faces 512d of the housing 512 with, e.g. a wrench, and rotating the housing 512 until the striker bolt assembly 510 is moved by a displacement D′, into a selected position. In this way, when the locking member 518 is in the unlocked position, the striker bolt housing 512 is freely moveable (i.e. rotatable about thread 512e).

As set forth with regard to the embodiment of the striker assembly 300 (FIGS. 4 to 10), the selected position, i.e. the optimal, ‘correct’ position of the housing 512 can be determined by the spacing between the fixed and moveable barriers. The housing 512 can be adjusted (as set forth above) into a position whereby the striker bolt 506 can extend across the space between the barriers and be received within the recess 202a of the latch assembly 200. Thus, the corresponding threads 512e, 516a of the respective housing 512 and insert 516 allow the striker bolt assembly 510 to be adjusted to the required, i.e. correct, striking distance.

When the striker bolt assembly 510 (and in turn, the striker assembly 500) are positioned at the correct striking distance, the striker bolt 506 is engageable with the strike face 204c of recess 202a (i.e. a component of the latch assembly 200). Thus, the striker bolt assembly 510 can be adjustable such that when the striker bolt 506 is moved to the extended position (i.e. when in proximity to the latch assembly 200), the striker assembly 500 can be in latching engagement with the latch assembly 200.

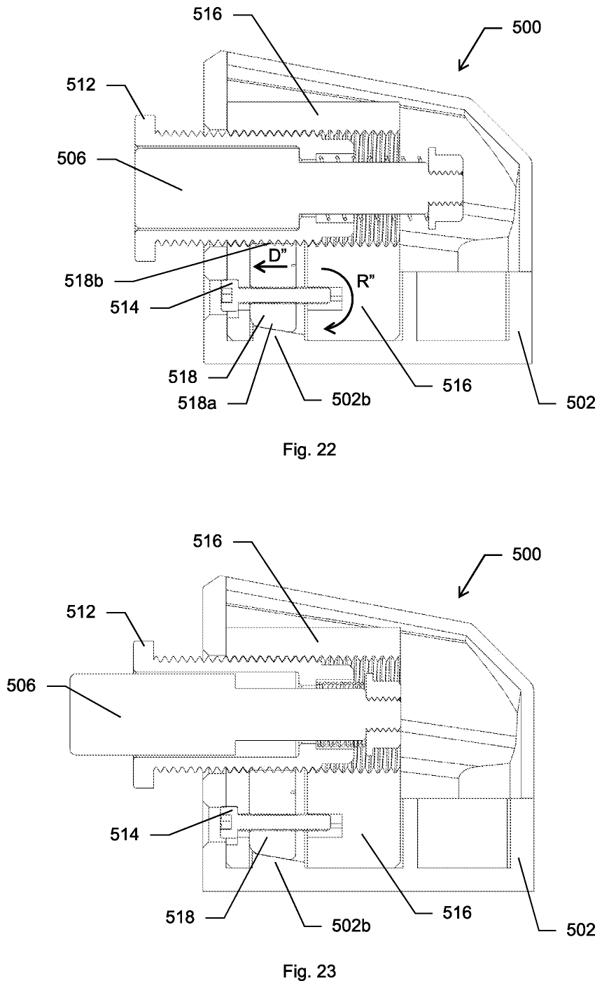

Once the correct striking distance has been selected for the striker bolt assembly 510 (as set forth above), the locking member 518 can be applied to secure the striker bolt assembly 510 in position. As illustrated in FIG. 22, the engagement surface 518b of the locking member 518 can be engaged with the external thread 512e of the housing 512 by rotation, R″ of the screw 514. As the screw 514 is rotated, the locking member 518 moves up the inclined surface 502b, indicated by displacement D″. This moves the engagement surface 518b into engagement with the external thread 512e so as to secure, i.e. prevent, the housing 512 from rotating. In other words, when the locking member 518 is in the locked position, the locking member 518 engages the striker bolt housing 512 to retain the striker bolt housing in the selected position.

Advantageously, the locking member 518 prevents the striker bolt assembly 510 from unintentional adjustment during use. For example, the locking member 518 can secure the striker bolt assembly 510 such that vibration of the gate (typically occurring during closure of the gate) does not change the position of the striker bolt assembly 510 within the insert 516.

In alternative embodiments, a biasing means (not shown) may be provided to bias the locking member 518 away from its locked position, i.e. to move the member 518 down the inclined surface 502b into an unlocked position. Alternatively, the biasing means (not shown) may be provided to bias the locking member 518 from its unlocked position, i.e. to move the member 518 up the inclined surface 502b into the locked position.

An example of the striker bolt assembly 510 in a selected position is shown in FIG. 23. In this example, the locking member 518 is also shown in the locked position with respect to the housing 512. In the selected position, the striker bolt assembly 510 is secured by the locking member 518 in a position whereby the flange 512c is spaced from the striker body 502. In this position, the striker bolt 506 (shown in the extended position) is able to extend further from the striker body 502 (in its extended position) than when the striker bolt assembly 510 is positioned closer to the body 502 (e.g. as shown in FIG. 20). In this way, the position of the proximal end 506b of the striker bolt 506 shown in FIG. 23 is an example of the striking distance required in order to latch, i.e. secure, the striker assembly to the latch assembly.

Advantageously, adjusting the striking distance, i.e. the position of the housing 512 relative to the body 502, allows the striker assembly 500 and the latch assembly 200 to engage, i.e. latch together, across differently sized gate gaps.

### Applications

Although the embodiments disclose the egress device being used on swimming gates and doors, it can be envisaged that the egress device can be used on other applications such as security fencing, zone restriction fencing, doors, fire exits, safety barriers, security barriers, care homes, garden gates, and child care applications etc.

Although the embodiments disclose the egress device 50 and remote driver 400 being configured to prevent young children gaining unauthorised or unsupervised access to the swimming area, where the remote driver 400 is mounted on the outside of the swimming pool barrier to restrict access to the pool area, it can be envisaged on playgrounds where location of egress device 50 and remote driver 400 can be reversed to prevent young children from leaving the playground unsupervised.

### Alternative Embodiments

In the claims which follow and in the preceding disclosure, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the present disclosure.

Accordingly, the present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods which can, of course, vary. It is also to be understood that the terminology used herein is for the purpose of describing particular embodiments only, and is not intended to be limiting.

As shown in the accompanying Figures and described above, the latch member 206 is shown in a form of a rocker 206, whereby the rocker 206 is pivotally mounted to the latch body 202. It can be envisaged the latch member 206 can be slidably mounted to the latch body 202, whereby the latch member 206 can move in a substantially linear manner or along a defined path of movement.

As shown in the accompanying Figures and described above, the first and second carriages 110, 210 are separate components. It can be envisaged first and second carriages 110, 210 can be a unitary component. In a configuration first and second carriages 110, 210 are a unitary component, the remote actuator 212 is not required.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope being indicated by the following claims.

1-42. (canceled)

43. An egress assembly configured for mounting to a moveable barrier and structure to releasably secure the moveable barrier to the structure, the movable barrier being movable between a closed position and an open position relative to the structure, the egress assembly comprising:
a striker assembly and a latch assembly, the striker assembly configured to co-operate with the latch assembly, wherein the striker assembly is configured to be mountable to the structure, and the latch assembly is configured to be mounted to the moveable barrier;
the striker assembly comprising a striker bolt, and a striker bolt housing containing at least a portion of the striker bolt, wherein the striker bolt is moveable between an extended position and a retracted position, the striker assembly including a biasing means that is adapted to urge the striker bolt towards the retracted position, wherein when the striker assembly and the latch assembly are in alignment the striker bolt extends from the striker bolt housing adopting the extended position, and when the striker assembly and the latch assembly are out of alignment the striker bolt retracts under the influence of the biasing means into the striker bolt housing adopting the retracted position;
the latch assembly being operable to retain the striker bolt in the extended position, the latch assembly comprising a keeper, a magnet, and a keeper latch member, the keeper having a latch face and a strike face, and the keeper being moveable between a first position and a second position relative to the magnet, wherein when the keeper is in the first position the strike face is engageable with the striker bolt, the magnet being positioned relative to the keeper to retain the striker bolt in the extended position when the striker assembly and the latch assembly are in alignment; and
an actuator assembly including an actuator moveable relative to a depressed position, wherein when the actuator is pushed into the depressed position the actuator assembly actuates the latch assembly by engaging a first end of the keeper latch member to move the keeper latch member to a released position to allow the striker bolt to be able to move the keeper to the second position as the moveable barrier is moved towards the open position;
wherein, in use, when the latch assembly is actuated, the striker bolt engages the strike face to move the keeper to the second position and allows the striker bolt to be movable to the retracted position under the influence of the biasing means when the striker bolt is out of alignment or substantially out of alignment with the latch assembly.

44. The egress assembly according to claim 43, wherein the keeper of the latch assembly is rotatable between the first and second positions.

45. The egress assembly according to claim 44, wherein, the keeper latch member extends between a first end and a second end, and the keeper latch member is rotatable between an engaged position and the released position such that when the keeper latch member is in the engaged position, the second end of the keeper latch member engages the latch face of the keeper to retain the keeper in the first position.

46. The egress assembly according to claim 45, wherein the keeper latch member further comprises a rotatable member provided at the second end, wherein the rotatable member engages the latch face of the keeper in the engaged position.

47. The egress assembly according to claim 45, wherein the latch assembly further comprises a second carriage extending between a second carriage first end and a second carriage second end, wherein the second carriage is moveable between an acting position and a neutral position, wherein, when the second carriage is in the acting position, the second carriage causes the keeper latch member to move to the released position.

48. The egress assembly according to claim 47, wherein the second carriage is slideable between the acting position and the neutral position.

49. The egress assembly according to claim 47, wherein the second carriage includes an abutment face that abuts with the first end of the keeper latch member to move the keeper latch member to the released position upon the second carriage moving to the acting position.

50. The egress assembly according to claim 43, wherein the latch assembly further comprises a biasing member which biases the keeper to the first position.

51. The egress assembly according to claim 43, wherein the keeper latch member further comprises a biasing member which biases the keeper latch member to the engaged position.

52. The egress assembly according to claim 51, wherein the magnet is adapted such that a magnetic force is greater than a biasing force produced by the biasing means so that the striker bolt moves towards the extended position when the latch assembly and the striker assembly are aligned.

53. The egress assembly according to claim 52, wherein the latch assembly includes a recess for receiving the striker bolt in the extended position, and the recess is in part defined by the strike face of the keeper and the magnet.

54. The egress assembly according to claim 53, wherein the recess is in juxtaposition or in axial alignment with the magnet.

55. The egress assembly according to claim 43, wherein the striker assembly comprises a striker body having an interior surface defining an interior cavity for receiving a striker bolt assembly, the striker bolt assembly comprising the striker bolt housing (512) and the striker bolt (506), the striker bolt housing (512) being configured to be co-axial with the striker bolt (506) and configured for receiving the striker bolt (506) in the retracted position, wherein at least a portion of an external surface of the striker bolt housing (512) is threaded to co-operate in threading engagement to allow the striker bolt assembly (510) to be adjustable relative to the striker body (502) to a selected position to allow alignment of the striker assembly (500) and the latch assembly (200) in latching engagement when the striker bolt (506) is in the extended position.

56. The egress assembly according to claim 55, further comprising a lock assembly including a locking member located in the interior cavity of the striker body, the locking member being moveable between a locked and an unlocked position, wherein when the locking member is in the locked position, the locking member engages the striker bolt housing to retain the striker bolt housing in the selected position, and when the locking member is in the unlocked position, the striker bolt housing is adjustable to a further selected position.

57. The egress assembly according to claim 56, wherein the locking member extends between a first and a second end in a longitudinal direction, the first end including an inclined surface, the inclined surface configured to mate with a corresponding inclined surface formed as part of the interior surface of the striker body, wherein the inclined surface and the corresponding inclined surface guide the locking member into the locked and unlocked positions, and the second end including an engagement surface for engaging an abutment surface of the striker bolt housing in the locked position.

58. The egress assembly according to claim 57, wherein the lock assembly further comprises an externally threaded actuator for moving the locking member relative to the striker bolt housing into the locked and the unlocked positions, wherein the locking member includes an internally threaded passage for receiving the externally threaded actuator, wherein rotational movement of the actuator translates to movement of the locking member in a lateral direction guided by the inclined surface and the corresponding inclined surface between the locked and the unlocked positions.

59. The egress assembly according to claim 58, wherein the striker bolt housing extends between a distal and a proximal end, the distal end being disposed inside the striker body, and the proximal end including a non-circular end region to allow a tool to grip the end region and rotate the striker bolt housing relative to the striker body to provide an adjustment of the striker bolt housing relative to the striker body to a still further selected position.

60. The egress assembly according to claim 59, wherein the striker bolt housing includes a flange extending at least in part around the proximal end, and the non-circular end region includes at least one flat face formed on the flange.

61. The egress assembly according to claim 55, wherein the striker assembly further comprises an insert disposed in the striker body, wherein at least a section of the external surface of the striker bolt housing is formed on the insert, the at least a section of the external surface formed on the insert including a threading for co-operating with the threading of the striker bolt housing.

62. An egress assembly according to claim 43, wherein the actuator assembly further comprises:
an elongate frame extending along a longitudinal axis between a first end and a second end, wherein the actuator is mounted relative to the elongate frame and operative to be depressible relative to the elongate frame in a transverse direction to the longitudinal axis of the elongate frame to actuate the latch assembly; and
a first carriage extending between a first carriage first end and a first carriage second end in the elongate frame, the first carriage being moveable between a driving position and a neutral position and the first carriage including an engagement face disposed at the first carriage second end to drive the keeper latch member to move to the released position when the first carriage is in the driving position.

63. The egress assembly according to claim 47, wherein:
the actuator assembly further comprises:
an elongate frame extending along a longitudinal axis between a first end and a second end, wherein the actuator is mounted relative to the elongate frame and operative to be depressible relative to the elongate frame in a transverse direction to the longitudinal axis of the elongate frame to actuate the latch assembly; and
a first carriage extending between a first carriage first end and a first carriage second end in the elongate frame, the first carriage being moveable between a driving position and a neutral position and the first carriage including an engagement face disposed at the first carriage second end to drive the keeper latch member to move to the released position when the first carriage is in the driving position; and
the engagement face of the first carriage engages an abutment face of the second carriage when the first carriage is in the driving position to cause the second carriage to move into the acting position of the second carriage.

64. The egress assembly according to claim 62, wherein the actuator assembly further comprises at least one bell crank pivotally connected to the actuator and the first carriage to translate a transverse force transmitted through angular rotation of the bell crank to a force transmitted in a longitudinal direction of the elongate frame towards the engagement face at the first carriage second end and the second end of the elongate frame through depression of the actuator and initial movement of the movable barrier to an open position.

65. The egress assembly according to claim 63, wherein when the actuator is released, the actuator is biased to a raised position which causes the first carriage and second carriage to move to respective neutral positions, the keeper latch member to rotate to the engaged position, and the keeper to rotate to the first position.

66. The egress assembly according to claim 65, further comprising a remote actuator for allowing the latch assembly to be operated from an opposite side of the movable barrier, the remote actuator extending between a first remote actuator end and a second remote actuator end, the first remote actuator end being configured to be coupled to a remote driver which causes the remote actuator to rotate, and the second remote actuator end being coupled to the second carriage and including a cam such that rotation of the remote actuator translates to movement of the second carriage to the acting position which causes movement of the keeper latch member to the released position.

67. An egress assembly for a movable barrier, the egress assembly comprising:
an actuator assembly and a latch arrangement;
the actuator assembly configured to be mounted to an elongate frame extending between a first end and a second end, the actuator assembly including an actuator operative to be depressible relative to the elongate frame to actuate the latch arrangement, the latch arrangement comprising a latch assembly and a striker assembly, the latch assembly and the striker assembly configured to co-operate in latching engagement, the latch assembly including a magnet and a keeper that is movable relative to the magnet on operation of the actuator, and the striker assembly including a striker bolt that is movable between an extended position and a retracted position that is attracted to the magnet to adopt the extended position, such that when the latch assembly and the striker assembly are aligned a magnetic force between the magnet and the striker bolt causes the striker bolt to move to the extended position and the latch assembly retains the striker bolt such that the latch arrangement is in a latched position;
wherein the actuator assembly and the latch assembly are mechanically connected and configured such that depression of the actuator and initial movement of the moveable barrier causes the magnet and striker bolt to move out of alignment which disengages the latch arrangement to allow the moveable barrier to move to the open position.

68. A striker assembly configured to co-operate with a latch assembly of a latch arrangement when used for an egress assembly, the latch assembly including a magnet and a keeper that is movable relative to the magnet, the striker assembly comprising:
a striker body including an interior surface defining an interior cavity;
a striker bolt housing and a striker bolt, whereby the interior cavity of the striker body houses the striker bolt housing and the striker bolt, the striker bolt housing and the striker bolt being configured to be co-axial with one another, the striker bolt being moveable to an extended position under an influence of the magnet of the latch assembly such that in the extended position the striker bolt is engageable with the keeper of the latch assembly in latching engagement;
wherein at least part of an external surface of the striker bolt housing is threaded to co-operate in threading engagement to allow a striker bolt assembly to be adjustable relative to the striker body to a selected position to facilitate alignment of the striker assembly and the latch assembly in latching engagement.

69. The striker assembly according to claim 68, further comprising a lock assembly including a locking member located in the interior cavity of the striker body, the locking member being moveable between a locked and an unlocked position, wherein when the locking member is in the locked position, the locking member engages the striker bolt housing to retain the striker bolt housing in the selected position, and when the locking member is in the unlocked position, the striker bolt housing is adjustable to a further selected position.

70. The striker assembly according to claim 69, wherein the locking member extends between a first and a second end in a longitudinal direction, the first end including an inclined surface, the inclined surface configured to mate with a corresponding inclined surface formed as part of the interior surface of the housing, wherein the inclined surface and the corresponding inclined surface guide the locking member into the locked and unlocked positions, and the second end including an engagement surface for engaging an abutment surface of the striker bolt housing in the locked position.

71. The striker assembly according to claim 70, wherein the lock assembly further comprises an externally threaded actuator for moving the locking member relative to the striker bolt housing into the locked and the unlocked positions, wherein the locking member includes an internally threaded passage for receiving the externally threaded actuator, wherein rotational movement of the actuator translates to movement of the locking member in a lateral direction guided by the inclined surface and corresponding inclined surface between the locked and the unlocked positions.

72. The striker assembly according to claim 71, wherein the striker bolt housing extends between a distal and a proximal end, the distal end being disposed inside the striker body, and the proximal end including a non-circular end region to allow a tool to grip the end region and rotate the striker bolt housing relative to the striker body to provide an adjustment of the striker bolt housing relative to the striker body to a still further selected position.

73. The striker assembly according to claim 72, wherein the striker bolt housing includes a flange extending at least in part around the proximal end, and the non-circular end region includes at least one flat face formed on the flange.

74. The striker assembly according to claim 68, wherein the striker assembly further comprises an insert disposed in the striker body, wherein at least a section of the external surface of the striker bolt housing is formed on the insert, the at least a section of the external surface formed on the insert including a threading for co-operating with the threading of the striker bolt housing.
